(19) United States
(12) Patent Application Publication
(10) Pub. No.: US 2024/0305490 A1
(43) Pub. Date: Sep. 12, 2024

(54) BLOCKCHAIN-BASED DATA PROCESSING METHOD, DEVICE, MEDIUM, AND PROGRAM PRODUCT

(71) Applicant: TENCENT TECHNOLOGY (SHENZHEN) COMPANY LIMITED, SHENZHEN (CN)

(72) Inventor: Gengliang ZHU, SHENZHEN (CN)

(73) Assignee: TENCENT TECHNOLOGY (SHENZHEN) COMPANY LIMITED, SHENZHEN (CN)

(21) Appl. No.: 18/664,455

(22) Filed: May 15, 2024

Related U.S. Application Data
(63) Continuation of application No. PCT/CN2023/097753, filed on Jun. 1, 2023.

(30) Foreign Application Priority Data
Aug. 15, 2022 (CN) 202210974228.5

(51) Int. Cl. H04L 9/00; H04L 9/32

(52) U.S. Cl. CPC H04L 9/50; H04L 9/3297

(57) ABSTRACT

Embodiments of the present disclosure disclose a blockchain-based data processing method, a device, and a readable storage medium. The method includes: in response to determining that a first state subtree satisfying a state archiving condition exists in a target state tree, generating an archiving transaction based on a first leaf node and a first sub-root node that are of the first state subtree; archiving the first state subtree to a service device in response to the archiving transaction being successfully uploaded, where a business service provided by the service device is associated with the first object information; and deleting, from the target state tree, a node other than the first sub-root node in the first state subtree, where the first sub-root node in the target state tree is configured for indicating that the first state subtree is archived.

### RELATED APPLICATION

This application is a continuation application of PCT Patent Application No. PCT/CN2023/097753, filed on Jun. 1, 2023, which claims priority to Chinese Patent Application No. 202210974228.5, filed with the China National Intellectual Property Administration on Aug. 15, 2022, both of which are incorporated herein by reference in their entireties, which is incorporated herein by reference in its entirety.

### FIELD OF THE TECHNOLOGY

This application relates to the field of Internet technologies, and in particular, to blockchain-based data processing.

### BACKGROUND OF THE DISCLOSURE

With rapid development of network technologies and attention of an enterprise on data security, a blockchain receives great attention and is widely applied.

Storage space of a blockchain with public credibility is limited. As a result, data stored in the blockchain continuously increases as the blockchain continuously works. In this case, the blockchain is in a dilemma of an insufficient storage resource.

The present disclosure describes embodiments for processing blockchain-based data, addressing at least one of the problems/issues discussed above, saving storage resource and/or alleviating storage restrictions/limitations on the blockchain, improving utilization of storage space of the blockchain, simplifying procedure of validity verification and/or existence verification, improving efficiency of validity verification and/or existence verification, improving efficiency of data acquisition, and/or facilitating orderliness of data archiving, and thus, improving blockchain technology and its applicability in the related technology field.

### SUMMARY

Embodiments of the present disclosure provide a blockchain-based data processing method, a device, a medium, and a program product, to alleviate a storage resource of the blockchain.

An aspect of embodiments of the present disclosure provides a blockchain-based data processing method, including:
if a consensus node detects that a first state subtree satisfying a state archiving condition exists in a target state tree, generating an archiving transaction based on a first leaf node and a first sub-root node that are of the first state subtree;
archiving the first state subtree to a service device if the archiving transaction is successfully uploaded; and
deleting, from the target state tree, a node other than the first sub-root node in the first state subtree.

An aspect of embodiments of the present disclosure provides a blockchain-based data processing apparatus. The blockchain-based data processing apparatus runs in a consensus node, and includes:
a first generation module, configured to: if the consensus node detects that a first state subtree satisfying a state archiving condition exists in a target state tree, generate an archiving transaction based on a first leaf node and a first sub-root node that are of the first state subtree;
a state archiving module, configured to: archive the first state subtree to a service device if the archiving transaction is successfully uploaded; and
a first deletion module, configured to: delete, from the target state tree, a node other than the first sub-root node in the first state subtree.

An aspect of the present disclosure provides a computer device, including: a processor, a memory, and a network interface.

The processor is connected to the memory and the network interface. The network interface is configured to provide a data communication function. The memory is configured to store a computer program. The processor is configured to invoke the computer program to enable the computer device to perform the method in embodiments of the present disclosure.

An aspect of embodiments of the present disclosure provides a computer-readable storage medium. The computer-readable storage medium stores a computer program. The computer program is adapted to be loaded by a processor to perform the method in embodiments of the present disclosure.

An aspect of embodiments of the present disclosure provides a computer program product. The computer program product includes a computer program, and the computer program is stored in a computer-readable storage medium. A processor of a computer device reads the computer program from the computer-readable storage medium. The processor executes the computer program to enable the computer device to perform the method in embodiments of the present disclosure.

In embodiments of the present disclosure, if it is detected that the first state subtree satisfying the state archiving condition exists in the target state tree, the archiving transaction may be generated based on the first leaf node and the first sub-root node that are of the first state subtree. The first state subtree may be archived to the service device if the archiving transaction is successfully uploaded. In addition, the node other than the first sub-root node in the first state subtree is deleted from the target state tree. In this case, the first sub-root node in the target state tree is configured for indicating that the first state subtree is archived. It can be learned from the above that, in embodiments of the present disclosure, the first state subtree satisfying the state archiving condition may be archived. A node related to the first state subtree may be deleted from the blockchain through the archiving, to reduce pressure of storing old data (including the first state subtree) in the blockchain, thereby alleviating the storage resource.

### BRIEF DESCRIPTION OF THE DRAWINGS

FIG. 1 is a schematic diagram of a system architecture according to an embodiment of the present disclosure;

FIG. 2a is a schematic diagram 1 of a scenario of blockchain-based data processing according to an embodiment of the present disclosure;

FIG. 2b is a schematic diagram 2 of a scenario of blockchain-based data processing according to an embodiment of the present disclosure;

FIG. 3 is a schematic flowchart 1 of a blockchain-based data processing method according to an embodiment of the present disclosure;

FIG. 4 is a schematic diagram 3 of a scenario of blockchain-based data processing according to an embodiment of the present disclosure;

FIG. 5 is a schematic diagram 4 of a scenario of blockchain-based data processing according to an embodiment of the present disclosure;

FIG. 6 is a schematic flowchart 2 of a blockchain-based data processing method according to an embodiment of the present disclosure;

FIG. 7 is a schematic diagram 5 of a scenario of blockchain-based data processing according to an embodiment of the present disclosure;

FIG. 8 is a schematic diagram 6 of a scenario of blockchain-based data processing according to an embodiment of the present disclosure;

FIG. 9 is a schematic flowchart 3 of a blockchain-based data processing method according to an embodiment of the present disclosure;

FIG. 10 is a schematic diagram 7 of a scenario of blockchain-based data processing according to an embodiment of the present disclosure;

FIG. 11 is a schematic diagram of a structure of a blockchain-based data processing apparatus according to an embodiment of the present disclosure; and

FIG. 12 is a schematic diagram of a structure of a computer device according to an embodiment of the present disclosure.

### DESCRIPTION OF EMBODIMENTS

The following clearly and completely describes the technical solutions in embodiments of the present disclosure with reference to the accompanying drawings in embodiments of the present disclosure. Apparently, the described embodiments are merely a part rather than all of the embodiments of the present disclosure. All other embodiments obtained by a person of ordinary skill in the art based on embodiments of the present disclosure without creative efforts shall fall within the protection scope of the present disclosure.

For ease of understanding, first, some nouns are briefly described below.

1. Blockchain: In a narrow sense, the blockchain is a chained data structure using a block as a basic unit. In the block, a previously obtained transaction history is verified by using a digital digest, and a requirement for tamper-proofing and scalability in a distributed ledger scenario is satisfied. In a broad sense, the blockchain also refers to a distributed ledger technology implemented by the blockchain structure, including a distributed consensus, privacy and security protection, a peer-to-peer communication technology, a network protocol, a smart contract, and the like. An objective of the blockchain is to implement a distributed data record ledger that allows only addition, but not deletion. A basic structure underlying the ledger is a linear linked list. The linked list is formed by connecting “blocks” in series. A hash value of a precursor block is recorded in a successor block. Whether each block (and a transaction in the block) is legal can be quickly verified by calculating the hash value. If a node in a network proposes to add a new block, consensus confirmation needs to be achieved for the block through a consensus mechanism.

A computing resource and storage space of a blockchain with public credibility are limited. As a result, when a quantity of blocks continuously increases, available storage space corresponding to the blockchain with public credibility may be insufficient, and a response is slower than a request. In this case, the storage space of the blockchain needs to be alleviated.

2. Hash value: The hash value is also referred to as a message feature value or feature value. The hash value is generated by using a hash algorithm that converts input data of any length into a cipher and performs fixed output. Original input data cannot be retrieved by decrypting the hash value, and the hash value is a unidirectional cryptographic function. The hash value is a potential core foundation and a most important aspect in a blockchain technology. The hash value preserves authenticity of recording and viewing data, and integrity of the blockchain that serves as a whole.

3. Blockchain node: A blockchain network distinguishes nodes into a consensus node (which may also be referred to as a core node or a full node) and a business node (which may also be referred to as a light node). The consensus node is responsible for a consensus business of an entire network of the blockchain. The business node is responsible for synchronizing ledger information of the consensus node, that is, synchronizing latest block data. Internal structures of both the consensus node and business node each include a network communication component. Because the blockchain network is essentially a peer-to-peer (P2P) network, the node needs to communicate with another node in the blockchain network through a P2P component. A resource and a service in the blockchain network are distributed in nodes, and information transmission and service implementation are performed directly between the nodes, without intervention of an intermediary link or a centralized server (a third party).

4. Merkle tree, Merkle root: The Merkle tree is a typical binary tree structure, including a root node (the Merkle root), a group of intermediate nodes, and a group of leaf nodes. A leaf node at a lowest layer stores data or a hash value thereof, and another node stores hash values of content of two sub-nodes thereof. In embodiments of the present disclosure, a target state tree is a Merkle tree generated for a state of object information. The object information may be address information (such as a digital wallet account) and business information (such as an invoice number).

5. Smart contract: The smart contract is a computer protocol intended to propagate, verify, or execute a contract in an informatization manner. In a blockchain system, the smart contract (referred to as a contract for short) is code that may be understood and executed by each node of a blockchain, and any logic may be executed to obtain a result. During actual application, the smart contract is managed and trialed through a transaction on the blockchain. Each transaction is equivalent to a remote procedure call (RPC) request to the blockchain system. If the smart contract is equivalent to an executable program, the blockchain is equivalent to an operating system that provides a running environment. The blockchain may include a plurality of contracts (such as a state archiving function in the present disclosure), distinguished by using a contract account and/or identifier (ID), an identification number, or a name.

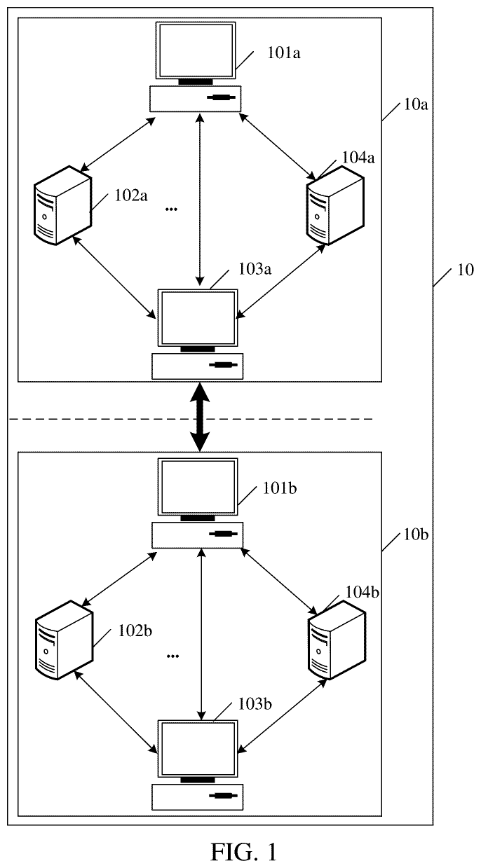

FIG. 1 is a schematic diagram of a system architecture according to an embodiment of the present disclosure. As shown in FIG. 1, the system architecture may be a blockchain network 10. The blockchain network 10 may include a witness network 10a and a consensus network 10b. A node in the witness network 10a may be referred to as a business node, having a part of data. The business node mainly performs business execution and does not participate in accounting consensus. The business node obtains block header data and a part of authorized visible data (such as the synchronization data described above) from the consensus network 10b through a manner of identity authentication. The consensus network 10b may also be referred to as a core network, and a node in the consensus network 10b may be referred to as a consensus node. The consensus node has full data. The witness network 10a and the consensus network 10b are in different network environments. Generally, the witness network 10a is in a public network, the consensus network 10b is in a private network, and the two networks interacts with each other through a routing boundary.

Refer to FIG. 1 again. The witness network 10a may include a business node 101a, a business node 102a, a business node 103a, . . . , and a business node 104a. The witness network 10a may include one or more witness networks. During actual application, one or more types of witness networks may be disposed due to different application scenarios, and a quantity of witness networks is not limited herein. The witness network 10a may include one or more business nodes, and a quantity of business nodes is not limited herein.

Refer to FIG. 1 again. The consensus network 10b may include a consensus node 101b, a consensus node 102b, a consensus node 103b, . . . , and a consensus node 104b. The consensus network 10b may include one or more consensus networks. During actual application, one or more types of consensus networks may be disposed due to different application scenarios, and a quantity of consensus networks is not limited herein. The consensus network 10b may include one or more consensus nodes, and a quantity of consensus nodes is not limited herein.

Each blockchain node (including the consensus node in the consensus network 10b and the business node in the witness network 10a) may receive transaction data (such as a first business transaction and a second business transaction described in the following) sent by a client during normal work and generate a block based on the received transaction data, and then upload the block. In specific implementations of the present disclosure, relevant data such as user information (such as the first business transaction) is involved. When embodiments of the present disclosure are applied to a specific product or technology, user permission or user agreement is required, and collection, use and processing of the relevant data need to comply with relevant laws, regulations and standards of relevant countries and regions.

To ensure data communication between the blockchain nodes, there may be a data connection between the blockchain nodes. For example, there is a data connection between the business node 101a and the business node 102a, there is a data connection between the business node 101a and the business node 103a, and there is a data connection between the consensus node 101b and the consensus node 104b.

Further, there is a data connection between the witness network 10a and the consensus network 10b. For example, there is a data connection between the business node 101a and the consensus node 102b, there is a data connection between the business node 101a and the consensus node 103b, and there is a data connection between the consensus node 101b and the business node 104a.

Data or a block may be transferred between the blockchain nodes through the data connections. The data connections between the blockchain nodes may be based on a node identifier. Each blockchain node in the blockchain network 10 has a corresponding node identifier. Each blockchain node may store a node identifier of another blockchain node with which the blockchain node has a connection relationship, to broadcast obtained data or a generated block to the another blockchain node based on the node identifier of the another blockchain node subsequently. For example, the business node 101a may maintain a node identifier list as shown in Table 1, and a node name and a node identifier of another blockchain node are saved in the node identifier list.

TABLE 1
Node identifier

| Node name | Node identifier |
|---|---|
| Consensus node 101b | AAAAA |
| Consensus node 102b | BBBBB |
| . . . | . . . |
| Consensus node 104b | CCCCC |
| Business node 102a | DDDDD |
| Business node 103a | EEEEE |
| . . . | . . . |

The node identifier may be an Internet Protocol (IP) address and any other type of information that can be used to identify the blockchain node in the blockchain network.

Assuming that a node identifier of the business node 101a is FFFFFF, business node 101a may send to-be-uploaded transaction data to the consensus node 104b through a node identifier CCCCC, and the consensus node 104b may determine that the to-be-on-uploaded transaction data is sent by the business node 101a through the node identifier FFFFFF. Similarly, the consensus node 104b may send a block consensus request to the consensus node 102b the rough a node identifier BBBBBB, and the consensus node 102b may determine that the block consensus request is sent by the consensus node 104b through the node identifier CCCCCC. Data transmission between other blockchain nodes is performed in the same way, and details are not described again.

The foregoing data connections do not limit a connection manner, and may be directly or indirectly connected through a wired communication manner, may be directly or indirectly connected through a wireless communication manner, or may be connected through another connection manner. This is not limited in the present disclosure.

The business node 101a, the business node 102a, the business node 103a, . . . , the business node 104a, the consensus node 101b, the consensus node 102b, the consensus node 103b, . . . , and the consensus node 104b shown in FIG. 1 may include a mobile phone, a tablet computer, a laptop computer, a palmtop computer, a smart speaker, a mobile Internet device (MID), a point of sales (POS) machine, a wearable device (such as a smart watch, a smart band), and the like.

The blockchain-based data processing method provided in embodiments of the present disclosure may be performed by a computer device. The computer device includes but is not limited to the business node (may be a terminal or a server) or the consensus node (may be a terminal or a server). The server may be an independent physical server, or may be a server cluster including a plurality of physical servers or a distributed system, or may be a cloud server providing basic cloud computing service, such as a cloud service, a cloud database, cloud computing, a cloud function, cloud storage, a network service, cloud communication, a middleware service, a domain name service, a security service, a content delivery network (CDN), big data, and an artificial intelligence platform. The terminal device includes but is not limited to a mobile phone, a computer, an intelligent voice interactive device, an intelligent appliance, a vehicle-mounted terminal, an aircraft, and the like. The terminal device and the server may be directly or indirectly connected in a wired or wireless communication manner. This is not limited in this embodiment of the present disclosure.

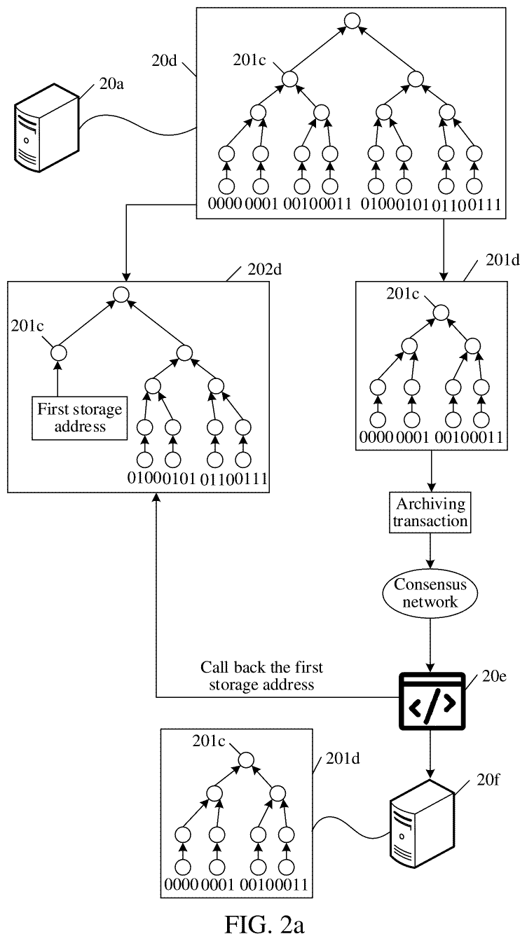

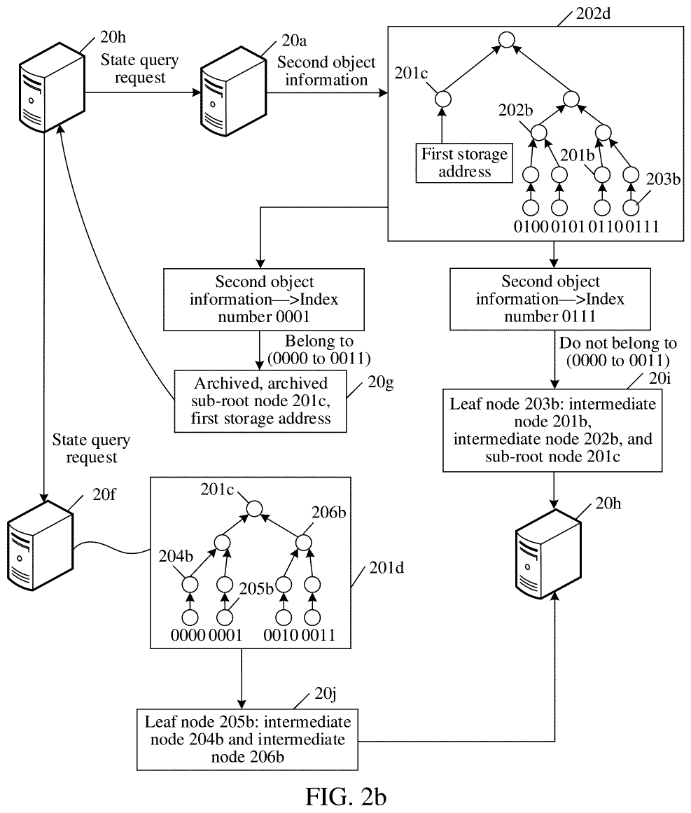

Further, FIG. 2a is a schematic diagram 1 of a scenario of blockchain-based data processing according to an embodiment of the present disclosure. This embodiment of the present disclosure may be applied to various scenarios including, but not limited to, a cloud technology, artificial intelligence, intelligent traffic, assisted driving, and the like. This embodiment of the present disclosure may be applicable to a business scenario such as an upload processing scenario, a change processing scenario, a destruction processing scenario, and a query processing scenario for object information (such as an address and a bill), and specific business scenarios are not enumerated herein. An implementation process of the data processing scenario may be performed in a consensus node of a blockchain, may be performed in a business node of the blockchain, or may be performed interactively in the consensus node and the business node. This is not limited herein. For ease of description and understanding, in this embodiment of the present disclosure, the implementation process being performed in the consensus node is used as an example for description. The consensus node may be any one of the consensus nodes in the consensus network 10b in the embodiment corresponding to FIG. 1.

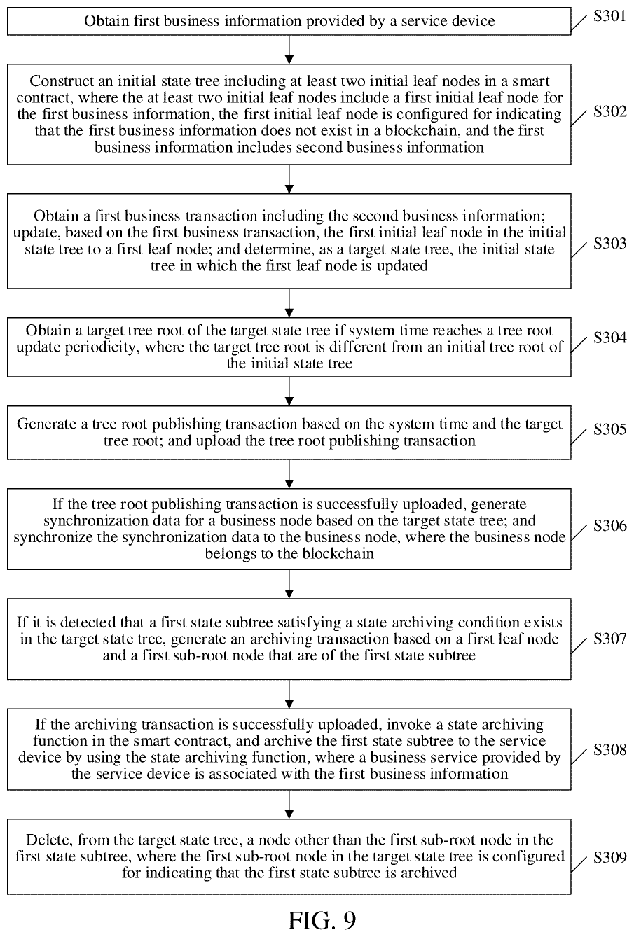

As shown in FIG. 2a, a consensus node 20a may generate a target state tree 20d. For a specific process of the consensus node 20a generating the target state tree 20d, refer to descriptions of FIG. 9 in the following. This is not described herein. The target state tree 20d is a Merkle tree for storing a current state of object information. The object information is not limited in this embodiment of the present disclosure, and may be a blockchain address. In this case, the target state tree 20d may be used to indicate a current state of a full address, for example, “address 1=20; address 2=50” may indicate that a current state (resource balance) of the address 1 is 20 and a current state of the address 2 is 50. The object information may be business information, such as an invoice number and a serial number that are with uniqueness. In this case, the target state tree 20d may be used to represent a current state of full business information. For example, “invoice number 1=0; invoice number 2=1; invoice number 3=2” may represent that a current state of the invoice number 1 is 0, where 0 may represent that an invoice 1 is in an un-uploaded state; a current state of the invoice number 2 is 1, where 1 may represent that an invoice 2 is in an invoiced state; and a current state of the invoice number 3 is 2, where 2 may represent that an invoice 3 is in a red-ink offset state.

The foregoing examples are described for easy understanding of the object information and the current state of the object information, and are not used to limit content of the target state tree. The content of the target state tree may be set based on an actual application scenario.

Refer to FIG. 2a again. The target state tree 20d may include a leaf node, an intermediate node, and a root node. Each leaf node has an index number, such as an index number 0000, an index number 0001, . . . , and an index number 0111 illustrated in FIG. 2a. The index number may indicate an index position of the leaf node in the target state tree 20d. This embodiment of the present disclosure does not limit a generation manner of the index number provided that the index number has uniqueness. One leaf node is used to indicate a current state of one piece of object information. A node at an upper layer of the leaf node is a hash value of the leaf node. A node at a further upper layer of the leaf node is a hash value corresponding to hash values of two leaf nodes.

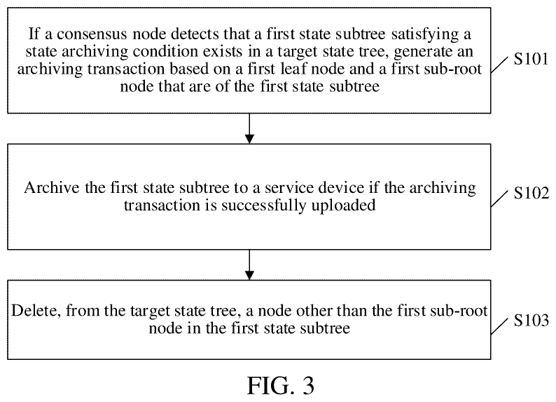

The consensus node 20a detects whether a state subtree satisfying a state archiving condition exists in the target state tree 20d. For a specific process of detecting the state subtree by the consensus node 20a, refer to descriptions of S101 in an embodiment corresponding to FIG. 3 in the following. This is not described herein. If the consensus node 20a detects that a first state subtree satisfying the state archiving condition exists in the target state tree 20d, an archiving transaction is generated based on a first leaf node and a first sub-root node that are of the first state subtree. For example, if a state subtree 201d (that is, the first state subtree) illustrated in FIG. 2a satisfies the state archiving condition, the consensus node 20a may generate the archiving transaction based on the first leaf node and the first sub-root node (such as a sub-root node 201c illustrated in FIG. 2a) that are of the state subtree 201d. The first leaf node of the state subtree 201d may include a leaf node indicated by the index number 0000, a leaf node indicated by the index number 0001, a leaf node indicated by the index number 0010, and a leaf node indicated by the index number 0011.

The consensus node 20a uploads the generated archiving transaction, and a specific process may include: the consensus node 20a broadcasts the archiving transaction to a consensus network, the consensus network performs consensus processing on the archiving transaction, and each consensus node stores the archiving transaction when the consensus is reached. If the archiving transaction is successfully uploaded, a state archiving function 20e in a smart contract is invoked, and the consensus node 20a archives the first state subtree (which is exemplified as the state subtree 201d in FIG. 2a) to a service device 20f by using the state archiving function 20e. A business service provided by the service device 20f is associated with first object information. The first object information refers to object information associated with the first leaf node. In this embodiment of the present disclosure, that one leaf node in the target state tree 20d is used to associate one piece of object information may also be understood as that one leaf node is used to indicated the current state of one piece of object information. For example, a leaf node indicated by the index number 0100, a leaf node indicated by the index number 0101, a leaf node indicated by the index number 0110, and a leaf node indicated by the index number 0111 are associated with different object information respectively, and are used to indicate current states of different object information respectively.

In this embodiment of the present disclosure, the state archiving function 20e has a function of calling back a first storage address for the first state subtree (such as the state subtree 201d illustrated in FIG. 2a) when the service device 20f successfully stores the first state subtree, and has a function of associatively storing the first storage address and the first sub-root node (such as the sub-root node 201c illustrated in FIG. 2a). As shown in FIG. 2a, when the state subtree 201d is successfully stored, the service device 20f may inform the consensus node 20a of the first storage address for storing the state subtree 201d by using the state archiving function 20e. By using the state archiving function 20e, the consensus node 20a may associatively store the first storage address and the sub-root node 201c.

After the archiving transaction is successfully uploaded, the consensus node 20a deletes, from the target state tree 20d, a node (briefly referred to as an old node for ease of representation) other than the first sub-root node (such as the sub-root node 201c in FIG. 2a) in the first state subtree (such as the state subtree 201d in FIG. 2a), to obtain a target state tree 202d. As shown in FIG. 2a, the target state tree 202d does not include the old node. In this case, the sub-root node 201c is configured for indicating that the state subtree 201d is archived.

An execution process of storing the first storage address may precede an execution process of deleting the old node, or the execution process of deleting the old node may precede the execution process of storing the first storage address. In some embodiments, the execution process of storing the first storage address is synchronized with the execution process of deleting the old node.

Further, refer to FIG. 2a and FIG. 2b together. FIG. 2b is a schematic diagram 2 of a scenario of blockchain-based data processing according to an embodiment of the present disclosure. A blockchain node 20h may be any one of the blockchain nodes in the blockchain, in other words, may be a consensus node or a business node, and may be the same blockchain node as the consensus node 20a or may not be the same blockchain node as the consensus node 20a. For ease of description, it is assumed that the blockchain node 20h is not the same blockchain node as the consensus node 20a in this embodiment of the present disclosure.

As shown in FIG. 2b, the consensus node 20a obtains a state query request that carries second object information and that is sent by the blockchain node 20h. The consensus node 20a determines, based on the state query request, a second index number having a mapping relationship with the second object information in the target state tree 202d.

If the second index number does not belong to a first index number for the first leaf node in the target state tree 202d, a leaf node indicated by the second index number is obtained. The first index number refers to the index number corresponding to the first leaf node of the state subtree 201d illustrated in FIG. 2a, such as the index numbers 0000 to 0011 illustrated in FIG. 2a. As illustrated in FIG. 2b, the second index number having the mapping relationship with the second object information is the index number 0111, which indicates a leaf node 203b, and the leaf node 203b has not been archived, that is, stored in the blockchain. Further, through the target state tree 202d, the consensus node 20a obtains verification data 20i of the leaf node 203b. The verification data 20i is a Merkle path for verifying validity of the leaf node 203b. As shown in FIG. 2b, the verification data 20i includes an intermediate node 201b (a hash value of the leaf node indicated by the index number 0110), an intermediate node 202b, and the sub-root node 201c.

Further, the consensus node 20a sends the leaf node 203b configured for indicating a current state of the second object information and the verification data 20i (that is, the intermediate node 201b, the intermediate node 202b, and the sub-root node 201c) to the blockchain node 20h. After the leaf node 203b and the verification data 20i are obtained by the blockchain node 20h, the validity of the leaf node 203b may be verified through the verification data 20i, and a specific process may include the following operations. The blockchain node 20h generates a to-be-verified hash value of the leaf node 203b, and performs hash calculation on the to-be-verified hash value of the leaf node 203b and the intermediate node 201b, to obtain a first intermediate to-be-verified hash value. The blockchain node 20h performs hash calculation on the first intermediate to-be-verified hash value and the intermediate node 202b, to obtain a second intermediate to-be-verified hash value. The blockchain node 20h performs hash calculation on the second intermediate to-be-verified hash value and the sub-root node 201c, to obtain a to-be-verified root hash value. The blockchain node 20h compares the to-be-verified root hash value with a root node of the target state tree 202d broadcast in the blockchain. If the to-be-verified root hash value is the same as the root node of the target state tree 202d, the blockchain node 20h determines the leaf node 203b as legitimate state data. Further, the blockchain node 20h may determine existence of the second object information based on the leaf node 203b. For example, the leaf node 203b is a current state value of an invoice number 8, if the leaf node 203b is equal to 0 for indicating the un-uploaded state, the blockchain node 20h may determine that an invoice corresponding to the invoice number 8 has not been uploaded, that is, the invoice corresponding to the invoice number 8 does not exist in the blockchain. If the leaf node 203b is equal to 1 for indicating the invoiced state, the blockchain node 20h may determine that the invoice corresponding to the invoice number 8 is in the invoiced state, that is, the invoice corresponding to the invoice number 8 exists in the blockchain. If the to-be-verified root hash value is different from the root node of the target state tree 202d, the blockchain node 20h determines the leaf node 203b as illegitimate state data.

The foregoing process is used to describe a scenario in which the second index number does not belong to the first index number. The following describes a scenario in which the second index number belongs to the first index number. As illustrated in FIG. 2b, in the target state tree 202d, the second index number having the mapping relationship with the second object information is set as the index number 0001, and it is clear that the index number 0001 belongs to the first index number (which is exemplified as the index numbers 0000 to 0011 in FIG. 2b) corresponding to the state subtree 201d. In this case, the consensus node 20a returns archiving prompt information 20g such as “archived, archived sub-root node 201c, first storage address” illustrated in FIG. 2b, to the blockchain node 20h. The sub-root node 201c indicates the first sub-root node.

After obtaining the archiving prompt information 20g, the blockchain node 20h obtains the first storage address in the archiving prompt information 20g, and sends, based on the first storage address, the state query request carrying the second object information to the service device 20f. Based on the state query request, the service device 20f obtains the second index number (such as the index number 0001 in FIG. 2b) corresponding to the second object information, and obtains, based on the second index number, the first state subtree (such as the state subtree 201d in FIG. 2b) including the second index number. Further, the service device 20f obtains the leaf node indicated by the index number 0001 in the state subtree 201d, as a leaf node 205b in FIG. 2b, and then obtains verification data 20j of the leaf node 205b. The verification data 20j are an intermediate node 204b configured for indicating a hash value of the leaf node indicated by the index number 0000 and an intermediate node 206b. The service device 20f returns both the leaf node 205b and the verification data 20j to the blockchain node 20h. After the blockchain node 20h obtains the leaf node 205b and the verification data 20j, validity verification and existence verification may be performed on the leaf node 205b based on the first sub-root node (that is, the sub-root node 201c in FIG. 2b) in the archiving transaction broadcast in the blockchain. The validity verification and existence verification performed on the leaf node 205b do not need to use the root node in the target state tree 202d, thereby procedure of the verification is simplified and efficiency of the verification is improved. In addition, the process of performing validity verification and existence verification on the leaf node 205b based on the verification data 20j and the sub-root node 201c by the blockchain node is the same as the process of performing validity verification and existence verification on the leaf node 203b based on the verification data 20i and the root node of target state tree 202d by the blockchain node, therefore details are not described herein and can refer to the foregoing descriptions.

It can be learned from the above that, in this embodiment of the present disclosure, the archiving the state subtree satisfying the state archiving condition (such as the first state subtree) in the target state tree may be understood as archiving excessively old state data on the blockchain, so that storage resource on the blockchain may be alleviated, and further, utilization of storage space of the blockchain may be improved. In addition, in this embodiment of the present disclosure, validity verification and existence verification may be performed on the leaf node belonging to the first index number (that is, the state value) through the first sub-root node of the archived first state subtree, thereby procedure of the verification is simplified and efficiency of the verification is improved.

Further, FIG. 3 is a schematic flowchart 1 of a blockchain-based data processing method according to an embodiment of the present disclosure. The blockchain-based data processing method may be performed by a consensus node of the blockchain, may be performed by a business node of the blockchain, or may be performed interactively by the consensus node and the business node. This is not limited herein. For ease of description and understanding, in this embodiment of the present disclosure, the method being performed by the consensus node is used as an example for description. The consensus node may be any one of the consensus nodes in the consensus network 10b in the embodiment corresponding to FIG. 1. As shown in FIG. 3, the blockchain-based data processing method may include at least the following S101 to S103.

S101: If a consensus node detects that a first state subtree satisfying a state archiving condition exists in a target state tree, generate an archiving transaction based on a first leaf node and a first sub-root node that are of the first state subtree.

As described above, the target state tree may include a leaf node, an intermediate node, and a root node. The root node is an ancestor of all nodes other than itself in the target state tree and has no parent node. In some embodiments, a sub-root node is described based on a subtree. For example, the first state subtree is a part of the target state tree, and a first sub-root node is a root node of the first state subtree. In the target state tree, the first sub-root node may not be the root node of the target state tree.

In a possible implementation, the first leaf node is configured for indicating a current state of first object information.

Specifically, a total quantity of first leaf nodes is determined, and if the total quantity of first leaf nodes is greater than or equal to an archiving quantity threshold, a generation timestamp of the first sub-root node is obtained. Maintenance duration of the first sub-root node is determined based on the generation timestamp, and if the maintenance duration is greater than or equal to a maintenance duration threshold, it is determined that the first state subtree satisfies the state archiving condition.

Specifically, in the target state tree, a first index number for the first leaf node is obtained. The archiving transaction is generated based on the first index number and the first sub-root node of the first state subtree, and the archiving transaction is uploaded.

This embodiment of the present disclosure does not limit a type of the target state tree and the object information, which may be set based on an actual application scenario.

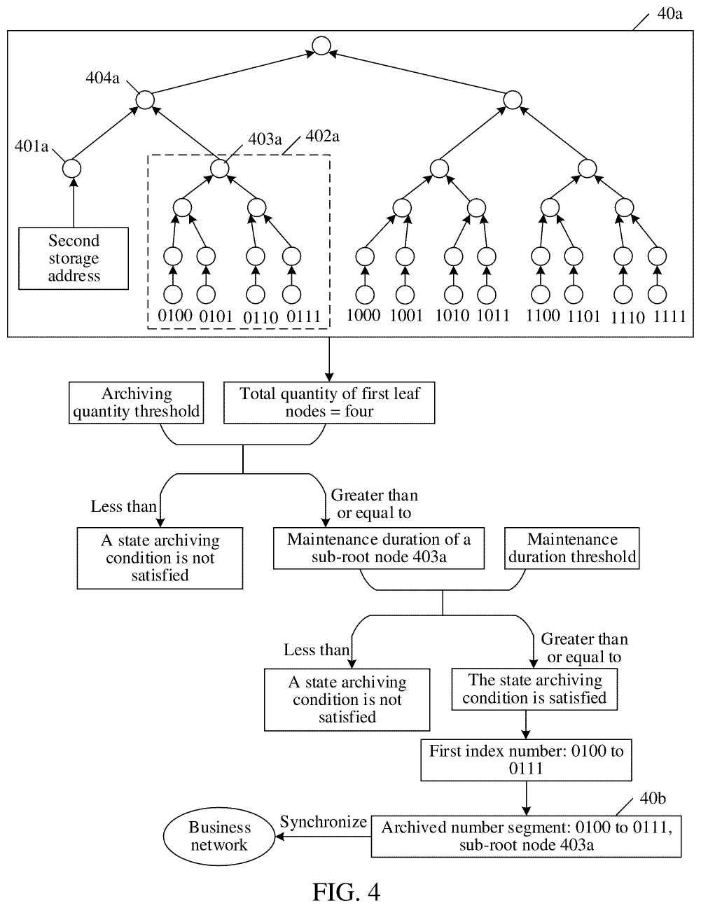

This embodiment of the present disclosure proposes a data archiving scheme. Archived state data has two characteristics: 1. A total quantity of archived leaf nodes (that is, state data) is necessary to be greater than or equal to a preset archiving quantity threshold, to avoid a case that a malicious device or a malicious blockchain node traverses all leaf nodes of an archived subtree, so as to prevent the malicious device or the malicious blockchain node from colliding a subroot to get all leaf nodes of the target state tree. 2. Duration remained unchanged by the archived leaf node is greater than or equal to a maintenance duration threshold, in other words, this embodiment of the present disclosure archives the state data when the state data is cold data. FIG. 4 is a schematic diagram 3 of a scenario of blockchain-based data processing according to an embodiment of the present disclosure. As shown in FIG. 4, the consensus node generates a target state tree 40a. A second state subtree is archived to the target state tree 40a. A second sub-root node of the second state subtree is a sub-root node 401a. The sub-root node 401a is associated with a second storage address, that is, an address for storing the second state subtree.

The consensus node detects a state subtree in the target state tree 40a, for example, a first state subtree 402a in FIG. 4, and a specific detection process may include the following operations. The consensus node obtains the first leaf node of the first state subtree 402a, that is, the leaf node indicated by the first index number, including a leaf node indicated by an index number 0100, a leaf node indicated by an index number 0101, a leaf node indicated by an index number 0110, and a leaf node indicated by an index number 0111. The consensus node determines a total quantity of first leaf nodes, and the total quantity of first leaf nodes being four is used as an example in this embodiment in the present disclosure. The consensus node compares the total quantity of first leaf nodes (that is, 4) with the archiving quantity threshold. If the archiving quantity threshold is greater than 4, in this case, the total quantity of first leaf nodes is less than the archiving quantity threshold, it is determined that the first state subtree 402a does not satisfy the state archiving condition. If the archiving quantity threshold is less than or equal to 4, in this case, the total quantity of first leaf nodes is greater than or equal to the archiving quantity threshold, the consensus node obtains a generation timestamp of a sub-root node 403a (that is, the first sub-root node) of the first state subtree 402a, and determines, based on the generation timestamp, maintenance duration of the sub-root node 403a. Further, the consensus node compares the maintenance duration of the sub-root node 403a with a maintenance duration threshold. If the maintenance duration is less than the maintenance duration threshold, it is determined that the first state subtree 402a does not satisfy the state archiving condition. If the maintenance duration is greater than or equal to the maintenance duration threshold, the consensus node determines that the first state subtree 402a satisfy the state archiving condition.

The consensus node may first perform the comparison of the total quantity of first leaf nodes with the archiving quantity threshold, may first perform the comparison of the maintenance duration of the sub-root node 403a with the maintenance duration threshold, or may perform the two comparisons synchronously.

Further, the consensus node obtains an index number corresponding to the first leaf node of the first state subtree 402a, that is, the first index number, such as index numbers 0100 to 0111 in FIG. 4. The first index number is configured for indicating an index position of the first leaf node in the target state tree 40a. The consensus node obtains the first sub-root node (such as the sub-root node 403a illustrated in FIG. 4), generates an archiving transaction 40b based on the first index number and the sub-root node 403a, and uploads the archiving transaction 40b.

S102: Archive the first state subtree to a service device if the archiving transaction is successfully uploaded.

In a possible implementation, the first state subtree may be archived to the service device by using a state archiving function invoked from a smart contract.

In a possible implementation, a business service provided by the service device is associated with the first object information.

Specifically, the archiving transaction is synchronized to a business node in the blockchain. The archiving transaction is configured for indicating the business node to perform, based on the first sub-root node, validity verification on to-be-verified object information associated with the first index number.

Specifically, if a parent node to which the second state subtree belongs and a parent node to which the first state subtree belongs are the same target node in the target state tree, the second storage address of the second state subtree in the service device is obtained. The second state subtree is a state subtree satisfying the state archiving condition in the target state tree, and an archiving timestamp corresponding to the second state subtree is earlier than an archiving timestamp corresponding to the first state subtree. The target node, the first state subtree, and the second storage address are sent to the service device respectively, to enable the service device to write the first state subtree and the target node based on the second storage address, and merge the first state subtree and the second state subtree, to obtain a merged state subtree. The target node is a tree root of the merged state subtree.

Refer to FIG. 4 again. If the archiving transaction 40b is successfully uploaded, the consensus node synchronizes the archiving transaction 40b to a business node in a business network, to enable the business node to self-verify a leaf node belonging to the first index number (that is, index numbers 0100 to 0111) based on the sub-root node 403a in the archiving transaction 40b. A process of self-verifying by the business node is the same as the process of verifying the leaf node 203b by the blockchain node 20h described in FIG. 2b, therefore details are not described herein, and can refer to the foregoing descriptions.

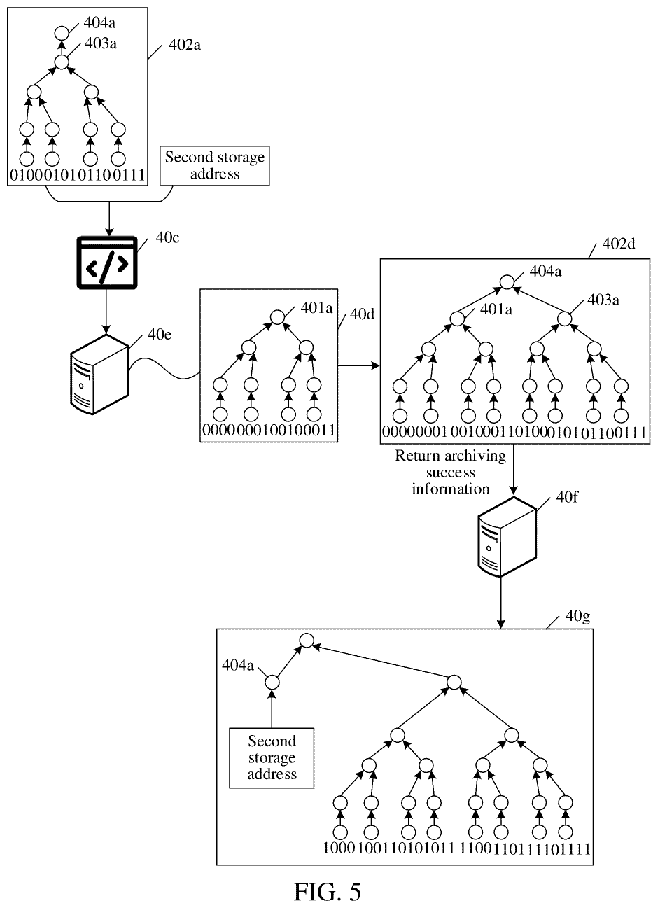

As illustrated in FIG. 4, the second sub-root node of the second state subtree is the sub-root node 401a, the first sub-root node of the first state subtree 402a is the sub-root node 403a, and the sub-root node 401a and the sub-root node 403a belong to the same parent node, that is, a parent node 404a, so that the consensus node may obtain the second storage address associatively stored with the second sub-root node (that is, the sub-root node 401a). The second storage address is an address at which the second state subtree is stored in the service device. Refer to FIG. 4 and FIG. 5 together. FIG. 5 is a schematic diagram 4 of a scenario of blockchain-based data processing according to an embodiment of the present disclosure. As shown in FIG. 5, the consensus node invokes a state archiving function 40c in the smart contract, and sends the first state subtree 402a carrying the parent node 404a and the second storage address to a service device 40e by using the state archiving function 40c.

The service device 40e in this embodiment of the present disclosure may include a device that provides object information (including the first object information), and provides a business transaction including the object information. The service device 40e includes but is not limited to a terminal device or a business server. The business server may be an independent physical server, or may be a server cluster including a plurality of physical servers or a distributed system, or may be a cloud server providing basic cloud computing service, such as a cloud database, a cloud service, cloud computing, a cloud function, cloud storage, a network service, cloud communication, a middleware service, a domain name service, a security service, a CDN, big data, and an artificial intelligence platform. The terminal device includes but is not limited to a mobile phone, a computer, an intelligent voice interactive device, an intelligent appliance, a vehicle-mounted terminal, an aircraft, and the like.

After obtaining the first state subtree 402a carrying the parent node 404a and the second storage address, the service device 40e writes the first state subtree 402a and the parent node 404a based on the second storage address. As shown in FIG. 5, a second state subtree 40d is archived to the service device 40e, and the second state subtree 40d includes the sub-root node 401a and a second leaf node, that is, a leaf node indicated by index numbers 0000 to 0011 respectively. The service device 40e merges the first state subtree 402a and the second state subtree 40d, and uses the parent node 404a as the root of the merged state subtree that is obtained after the merging process, for example, a merged state subtree 402d shown in FIG. 5, which includes the first state subtree 402a, the second state subtree 40d, and the parent node 404a. The two state subtrees belonging to the same parent node are merged, so that the two state subtrees can be obtained by reading a file once when obtaining the state subtree subsequently, to avoid reading the file twice, thereby improving efficiency of data acquisition and also facilitating orderliness of data archiving.

S103: Delete, from the target state tree, a node other than the first sub-root node in the first state subtree. In some implementations, S103 may include deleting, from the target state tree, all nodes except the first sub-root node in the first state subtree.

In a possible implementation, the first sub-root node in the target state tree is configured for indicating that the first state subtree is archived. The “archived” refers to a completion of archiving the first state subtree.

Specifically, the first sub-root node and the second sub-root node of the second state subtree are deleted synchronously. The target node in the target state tree is configured for indicating that both the first state subtree and the second state subtree are archived.

Refer to FIG. 4 and FIG. 5 again. The sub-root node 403a of the first state subtree 402a and the sub-root node 401a of the second state subtree 40d belong to the same parent node, that is, the parent node 404a, so that the consensus node archives the first state subtree 402a and the parent node 404a to the second storage address of the archived second state subtree 40d. Therefore, when obtaining archiving success information returned by the service device 40e, the consensus node 40f deletes, from the target state tree 40a, both the first state subtree 402a and the sub-root node 401a (that is, the second sub-root node), to obtain a target state tree 40g in FIG. 5. In this case, the second storage address is associatively stored with the parent node 404a.

It can be learned from the above that, this embodiment of the present disclosure proposes the state data archiving scheme. When the first state subtree satisfies the state archiving condition, the archiving transaction is generated based on the first index number corresponding to the first state subtree and the first sub-root node. Consensus processing is performed on the archiving transaction, the archiving transaction is stored when the consensus is reached, and the archiving transaction is synchronized to the business node. In this case, the business node may perform verification with higher performance on object information with a fixed state by using the first sub-root node. In addition, the nodes other than the first sub-root node in the archived first state subtree are deleted on the chain, so that pressure of storing data on the chain can be reduced and storage resource can be alleviated. Further, if the first sub-root node and the second sub-root node of the archived second state subtree belong to the same parent node, the first state subtree may be archived to the second storage address to which the second state subtree is archived, so that the archived state data is maintained in order, and the two state subtrees can be read by reading a file once during subsequent reading, thereby improving efficiency of data acquisition.

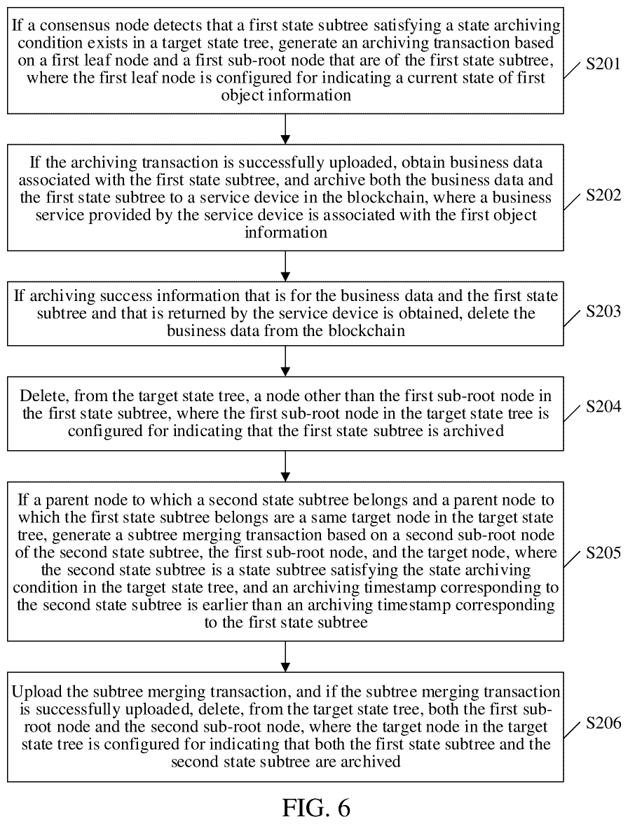

FIG. 6 is a schematic flowchart 2 of a blockchain-based data processing method according to an embodiment of the present disclosure. The blockchain-based data processing method may be performed by a consensus node of the blockchain, may be performed by a business node of the blockchain, or may be performed interactively by the consensus node and the business node. This is not limited herein. For ease of description and understanding, in this embodiment of the present disclosure, the method being performed by the consensus node is used as an example for description. The consensus node may be any one of the consensus nodes in the consensus network 10b in the embodiment corresponding to FIG. 1. As shown in FIG. 6, the method may include at least the following operations.

S201: If a consensus node detects that a first state subtree satisfying a state archiving condition exists in a target state tree, generate an archiving transaction based on a first leaf node and a first sub-root node that are of the first state subtree. The first leaf node is configured for indicating a current state of first object information.

For a specific implementation process of S201, refer to S101 in the embodiment corresponding to FIG. 3. Details are not described herein.

S202: If the archiving transaction is successfully uploaded, obtain business data associated with the first state subtree, and archive both the business data and the first state subtree to the service device in the blockchain. A business service provided by the service device is associated with the first object information.

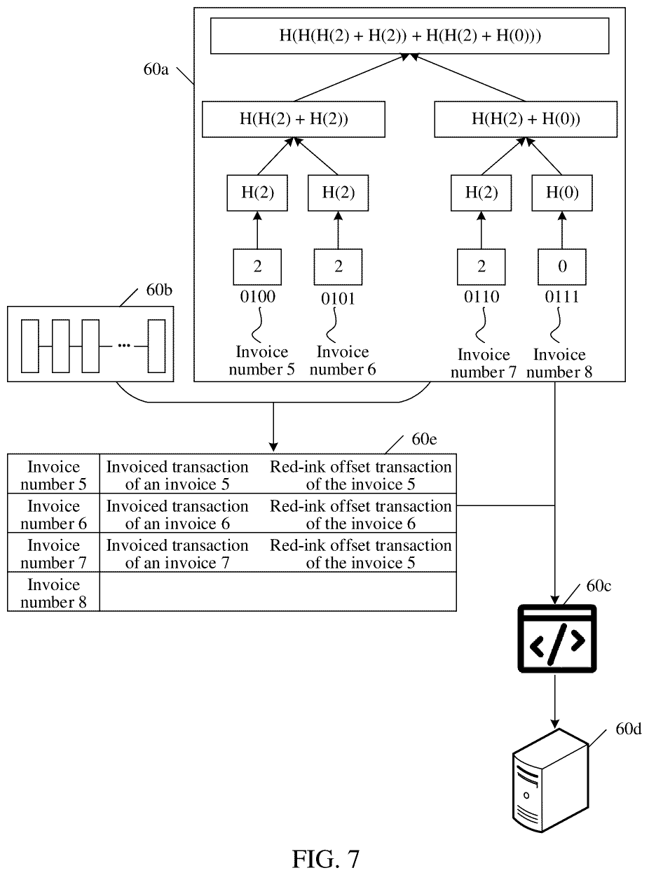

For ease of understanding, in this embodiment of the present disclosure, the target state tree is exemplified as an invoice state tree, that is, a Merkle tree for recording a current state of the invoice. In this embodiment of the present disclosure, business data that is on the blockchain and that is associated with a to-be-archived invoice state may be synchronously archived through the invoice state. FIG. 7 is a schematic diagram 5 of a scenario of blockchain-based data processing according to an embodiment of the present disclosure. As shown in FIG. 7, the first leaf node corresponding to a first state subtree 60a includes a leaf node indicated by an index number 0100, a leaf node indicated by an index number 0101, a leaf node indicated by an index number 0110, and a leaf node indicated by an index number 0111.

The leaf node indicated by the index number 0100 is configured for indicating a current state of an invoice corresponding to an invoice number 5 (referred to as an invoice 5 for short), and the leaf node is set to a first state value (such as 2 in FIG. 7) that represents a red-ink offset state, that is, the current state of the invoice 5 is the red-ink offset state. The leaf node indicated by the index number 0101 is configured for indicating a current state of an invoice corresponding to an invoice number 6 (referred to as an invoice 6 for short), and the leaf node is set to the first state value (such as 2 in FIG. 7) that indicates the red-ink offset state, that is, the current state of the invoice 6 is the red-ink offset state. The leaf node indicated by the index number 0110 is configured for indicating a current state of an invoice corresponding to an invoice number 7 (referred to as an invoice 7 for short), and the leaf node is set to the first state value (such as 2 in FIG. 7) that represents the red-ink offset state, that is, the current state of the invoice 7 is the red-ink offset state. The leaf node indicated by the index number 0111 is configured for indicating a current state of an invoice corresponding to an invoice number 8 (referred to as an invoice 8 for short), and the leaf node is set to a second state value (such as 0 in FIG. 7) that indicates an inexistence state, that is, the current state of the invoice 8 is that there is no invoice 8 in the blockchain.

The foregoing descriptions are to facilitate understanding of the exemplified states and state values. During actual application, the state of the invoice may also include destruction, auditing, and the like, and the state value thereof may be set based on an actual application scenario. In addition, an application of another bill scenario may be understood with reference to the descriptions of this embodiment of the present disclosure.

In this embodiment of the present disclosure, a layer of the first leaf node in the first state subtree 60a is set to a first layer, that is, a node in the first layer of the first state subtree 60a is the first leaf node. A node in a second layer is a state hash value obtained by performing hash calculation on the first leaf node, including a state hash value H (2) of the leaf node indicated by the index number 0100, the state hash value H (2) of the leaf node indicated by the index number 0101, the state hash value H (2) of the leaf node indicated by the index number 0110, and a state hash value H (0) of the leaf node indicated by the index number 0111. A node in a third layer of the first state subtree 60a is a merged state hash value obtained by performing hash calculation on two adjacent state hash values, including a merged state hash value H (H (2)+H (2)) and a merged state hash value H (H (2)+H (0)). A node in a fourth layer of the first state subtree 60a is a sub-root node, that is, a sub-root state hash value H (H (H (2)+H (2))+H (H (2)+H (0))).

When it is determined that the first state subtree 60a satisfies the state archiving condition, the consensus node generates an archiving transaction for the first state subtree 60a, and uploads the archiving transaction. If the archiving transaction is successfully uploaded, the consensus node obtains, in a blockchain 60b, business data associated with the first state subtree 60a, such as business data 60e illustrated in FIG. 7. The business data 60e includes business data corresponding to the invoice number 5, business data corresponding to the invoice number 6, business data corresponding to the invoice number 7, and business data corresponding to the invoice number 8. The business data corresponding to the invoice number 5 may include an invoiced transaction of the invoice 5, that is, a business transaction representing that the invoice 5 is invoiced, and a red-ink offset transaction of the invoice 5, that is, a business transaction representing that the invoice 5 is red-ink offset. The business data corresponding to the invoice number 5 may also include data associated with the invoiced transaction of the invoice 5, such as a read-write set and a transaction tree. Specific content of the business data may be determined based on an actual application scenario. This is not limited in this embodiment of the present disclosure.

The business data corresponding to the invoice number 6 may include an invoiced transaction of the invoice 6, that is, a business transaction representing that the invoice 6 is invoiced, and a red-ink offset transaction of the invoice 6, that is, a business transaction representing that the invoice 6 is red-ink offset. Similarly, the business data corresponding to the invoice number 6 may also include data associated with the invoiced transaction of the invoice 6, and data associated with the red-ink offset transaction of the invoice 6. The business data corresponding to the invoice number 7 may include an invoiced transaction of the invoice 7, that is, a business transaction representing that the invoice 7 is invoiced, and a red-ink offset transaction of the invoice 7, that is, a business transaction representing that the invoice 7 is red-ink offset. Similarly, the business data corresponding to the invoice number 7 may also include data associated with the invoiced transaction of the invoice 7, and data associated with the red-ink offset transaction of the invoice 7. The current state of the invoice 8 is that there is no invoice 8 in the blockchain, so that there is no business data associated with the invoice number 8 stored in the blockchain temporarily.

Further, the consensus node invokes a state archiving function 60c in a smart contract, and archives, based on the state archiving function 60c, both the business data 60e and the first state subtree 60a to a service device 60d.

S203: If archiving success information that is for the business data and the first state subtree and that is returned by the service device is obtained, delete the business data from the blockchain.

Specifically, in this embodiment of the present disclosure, business data associated with the archived state subtree such as the first state subtree 60a in FIG. 7 may be archived, so that after being successfully archived, the archived business data (such as the business data 60e in FIG. 7) may be deleted from the blockchain. As the blockchain continuously works, data stored in the blockchain becomes more, and consequently, storage space of the blockchain becomes smaller and a storage resource of the blockchain becomes tighter. In this embodiment of the present disclosure, the storage resource of the blockchain may be alleviated by deleting excessively old business data to improve utilization of the storage space of the blockchain.

S204: Delete, from the target state tree, a node other than the first sub-root node in the first state subtree. The first sub-root node in the target state tree is configured for indicating that the first state subtree is archived.

For a specific implementation process of S204, refer to the foregoing descriptions in the embodiment corresponding to FIG. 2a. Details are not described herein.

Further, an execution process of S204 may precede an execution process of deleting the business data in S203. In some embodiments, the execution process of S204 is synchronized with the execution process of deleting the business data in S203.

S205: If a parent node to which a second state subtree belongs and a parent node to which the first state subtree belongs are the same target node in the target state tree, generate a subtree merging transaction based on a second sub-root node of the second state subtree, the first sub-root node, and the target node. The second state subtree is a state subtree satisfying the state archiving condition in the target state tree, and an archiving timestamp corresponding to the second state subtree is earlier than an archiving timestamp corresponding to the first state subtree.

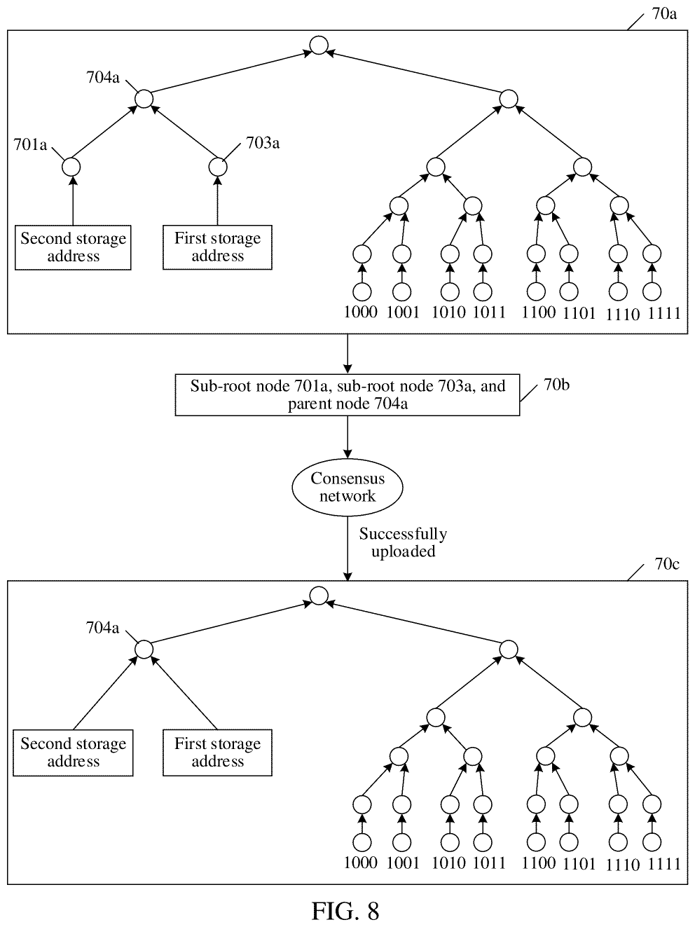

This operation is different from the foregoing S102 in FIG. 3. S102 describes the process of archiving the first state subtree satisfying the state archiving condition to the address stored with the archived second state subtree. This operation is used to describe the processing of the first state subtree satisfying the state archiving condition after being archived. FIG. 8 is a schematic diagram 6 of a scenario of blockchain-based data processing according to an embodiment of the present disclosure. As shown in FIG. 8, the target state tree 70a includes a second sub-root node 701a of the second state subtree, and a first sub-root node 703a of the first state subtree. The second state subtree is archived to a second storage address and the first state subtree is archived to a first storage address. The first storage address may be the same as the second storage address or the first storage address may be different from the second storage address. In addition, for a meaning of other description data of the target state tree 70a illustrated in FIG. 8, refer to the foregoing descriptions. Details are not described herein.

Refer to FIG. 8 again. It is clear that, a parent node to which the first sub-root node 703a belongs and a parent node to which the second sub-root node 701a belongs are the same node in the target state tree 70a, that is, a parent node 704a. In this case, the consensus node may generate a subtree merging transaction 70b based on the second sub-root node 701a, the first sub-root node 703a, and the parent node 704a.

S206: Upload the subtree merging transaction, and if the subtree merging transaction is successfully uploaded, delete, from the target state tree, both the first sub-root node and the second sub-root node. The target node in the target state tree is configured for indicating that both the first state subtree and the second state subtree are archived.

Refer to FIG. 8 again. The consensus node uploads the subtree merging transaction 70b, and deletes, from the target state tree 70a, both the first sub-root node 703a and the second sub-root node 701a if the subtree merging transaction 70b is successfully uploaded. The consensus node associatively stores the parent node 704a, the second storage address, and the first storage address, to obtain a target state tree 70c as illustrated in FIG. 8.

It can be learned from the above that, in this embodiment of the present disclosure, the first state subtree satisfying the state archiving condition may be archived. Through the archiving, storage of old data (including the first state subtree) in the blockchain is reduced, thereby alleviating the storage resource. Further, in this embodiment of the present disclosure, the business data associated with the first state subtree and the first state subtree are synchronously archived, so that the storage resource is further alleviated.

FIG. 9 is a schematic flowchart 3 of a blockchain-based data processing method according to an embodiment of the present disclosure. The blockchain-based data processing method may be performed by a consensus node of the blockchain, may be performed by a business node of the blockchain, or may be performed interactively by the consensus node and the business node. This is not limited herein. For ease of description and understanding, in this embodiment of the present disclosure, the method being performed by the consensus node is used as an example for description. The consensus node may be any one of the consensus nodes in the consensus network 10b in the embodiment corresponding to FIG. 1. As shown in FIG. 9, the method may include at least the following operations.

S301: Obtain first business information provided by a service device.

Specifically, at least two pieces of business information provided by the service device are obtained, and the at least two pieces of business information include the first business information.

S302: Construct an initial state tree including at least two initial leaf nodes in a smart contract. The at least two initial leaf nodes include a first initial leaf node for the first business information. The first initial leaf node is configured for indicating that a business transaction including the first business information does not exist in the blockchain. The first business information includes second business information.

Specifically, a total quantity of pieces of information of the at least two pieces of business information is determined, and based on the total quantity of pieces of information, a total quantity of leave is determined. The initial state tree including the at least two initial leaf nodes is constructed in the smart contract. A total quantity of at least two initial leaf nodes is equal to the total quantity of leaves. Index numbers respectively configured for indicating the at least two initial leaf nodes are determined in the initial state tree. The at least two index numbers include a first index number configured for indicating the first initial leaf node. A mapping relationship is established for the at least two index numbers and the at least two pieces of business information. The mapping relationship exists between the first index number and the first business information.

Combining the descriptions of S301 and S302, this embodiment of the present disclosure proposes a new state tree. First, the at least two pieces of business information provided by the service device are obtained. For ease of understanding and description, in this embodiment of the present disclosure, the business information is exemplified as bill information, and the bill information includes, but is not limited to an invoice number and a transaction flow number.

None of at least two pieces of bill information sent by the service device generate a corresponding bill in the blockchain. The consensus node constructs, based on the obtained at least two pieces of bill information, the initial state tree including the at least two initial leaf nodes in the smart contract. The total quantity of at least two initial leaf nodes is greater than or equal to a total quantity of at least two pieces of bill information.

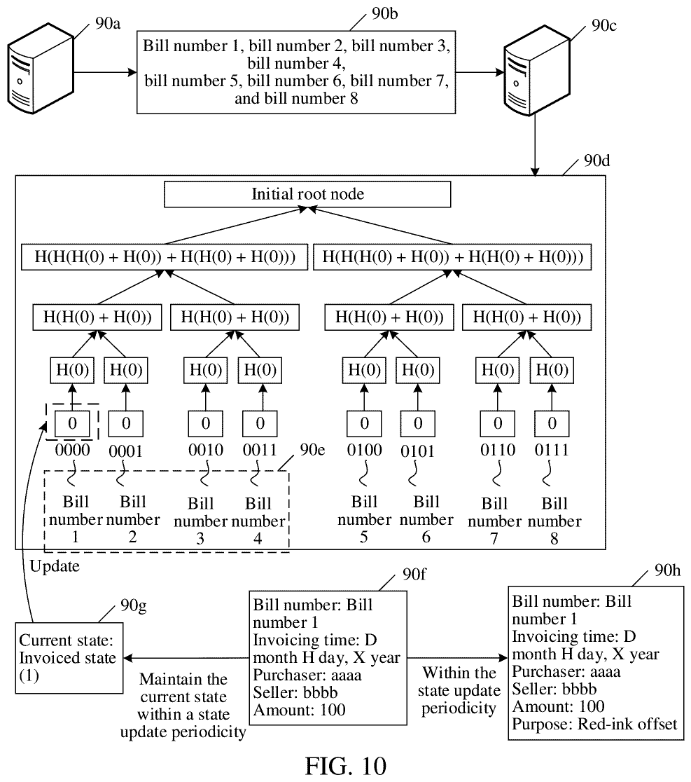

FIG. 10 is a schematic diagram 7 of a scenario of blockchain-based data processing according to an embodiment of the present disclosure. As shown in FIG. 10, a service device 90a sends at least two pieces of bill information 90b to a consensus node 90c. The at least two pieces of bill information 90b may include a bill number 1, a bill number 2, a bill number 3, a bill number 4, a bill number 5, a bill number 6, a bill number 7, and a bill number 8. For ease of description, in this embodiment of the present disclosure, the total quantity of pieces of information equal to eight is used as an example. During actual application, the total quantity of pieces of information may be any number.

The consensus node 90c may generate an initial state tree 90d after obtaining the at least two bill information 90b. Because none of the at least two pieces of bill information 90b generate a corresponding bill, a state value in each initial leaf node in the initial state tree 90d is an initial state value. The initial state value is exemplified as 0 in FIG. 10, which indicates that the bill does not exist in the blockchain. A meaning of each layer of nodes in the initial state tree 90d is the same as that in the target state tree 60a in FIG. 7, therefore details are not described herein and can refer to the foregoing descriptions of the target state tree 60a.

As shown in FIG. 10, the at least two bill information 90b include first bill information 90e. The first bill information 90e may include the bill number 1, the bill number 2, the bill number 3, and the bill number 4. A first initial leaf node 90e may include an initial leaf node for the bill number 1, an initial leaf node for the bill number 2, an initial leaf node for the bill number 3, and an initial leaf node for the bill number 4, that is, an initial leaf node indicated by an index number 0000, an initial leaf node indicated by an index number 0001, an initial leaf node indicated by index number an 0010, and an initial leaf node indicated by an index number 0011.

S303: Obtain first business transaction including the second business information, update, based on the first business transaction, the first initial leaf node in the initial state tree to a first leaf node, and determine, as a target state tree, the initial state tree in which the first leaf node is updated.

Specifically, the first business transaction is uploaded, and if the first business transaction is successfully uploaded, a current state of the second business information is obtained based on the first business transaction. A current state value configured for indicating the current state of the second business information is generated based on the current state of the second business information. The first initial leaf node is updated based on the current state value, to obtain the first leaf node.

A specific process of generating, based on the current state of the second business information, the current state value configured for indicating the current state of the second business information may include: if a second business transaction including the second business information is obtained within a state update periodicity for the current state of the second business information and the second business transaction is successfully uploaded, obtaining, based on the second business transaction, an updated state configured for updating the current state of the second business information; or if the current state of the second business information is maintained within the state update periodicity, generating the current state value configured for indicating the current state of the second business information.

A specific process of updating the first initial leaf node based on the current state value to obtain the first leaf node may include: updating an initial state value of the first initial leaf node to the current state value, where the first initial leaf node indicates, through the initial state value, that the business transaction including the first business information does not exist in the blockchain; and determining, as the first leaf node, the first initial leaf node in which the current state value is updated.

As a business transaction including the bill number is uploaded, the initial state value in the initial leaf node in the initial state tree is updated. Refer to FIG. 10 again. The consensus node 90c obtains a business transaction 90f. The business transaction 90f is a transaction bill between a purchaser aaaa and a seller bbbb, a transaction amount is 100, a bill number of the transaction bill is the bill number 1, and the bill is invoiced on D month H day, X year. In this embodiment of the present disclosure, the first business transaction is exemplified by the business transaction 90f including the bill number 1. A processing procedure of a business transaction corresponding to another bill information is the same as the processing procedure of the business transaction 90f, so that the processing procedure of the business transaction 90f can be referred to.

The consensus node 90c uploads the business transaction 90f, and if the business transaction 90f is successfully uploaded, the consensus node 90c determines the current state of the bill number 1 based on the business transaction 90f. In this operation, the current state of the bill number 1 is exemplified as an invoiced state. Further, the consensus node 90c detects whether the invoiced state for the bill number 1 is updated within the state update periodicity. As illustrated in FIG. 10, if the invoiced state for the bill number 1 is unchanged within the state update periodicity, the consensus node 90c generates a current state value configured for indicating the invoiced state of the bill number 1. The invoiced state is exemplified as 1 in FIG. 10. Further, the consensus node 90c updates the initial state value (such as 0 in FIG. 10) in the initial leaf node indicated by the index number 0000 to the current state value (such as 1 in FIG. 10). In this case, the first initial leaf node 90e is updated to the first leaf node.

A state value in a leaf node may be updated until a state archiving condition is met, or until an archiving process is performed. The state value in the leaf node is no longer updated when the state archiving condition is met or the archiving process is performed.

In some embodiments, if the consensus node 90c obtains a second business transaction including the bill number 1 (such as a business transaction 90h illustrated in FIG. 10) within the state update periodicity for the invoiced state of the bill number 1, the consensus node 90c uploads the business transaction 90h, and if the business transaction 90h is successfully uploaded, the initial leaf node indicated by the index number 0000 skips the invoiced state, that is, is not updated to the invoiced state. In this case, detection is performed on the state update periodicity for a red-ink offset state of the bill number 1. A subsequent processing procedure is the same as the procedure of the consensus node 90c processing the business transaction 90f, and details are not described herein.

In this embodiment of the present disclosure, for ease of understanding, the second business information is exemplified as the bill number 1, the first business transaction is exemplified as the business transaction 90f, and for state updates corresponding to other bill information, refer to the foregoing descriptions and details are not described herein. In addition, during actual application, there are some bills that are not uploaded, and in this case, for the bills that are not uploaded in the blockchain, states thereof are that they do not exist in the blockchain.

S304: Obtain a target tree root of the target state tree if system time reaches a tree root update periodicity. The target tree root is different from an initial tree root of the initial state tree.

S305: Generate a tree root publishing transaction based on the system time and the target tree root, and upload the tree root publishing transaction.

S306: If the tree root publishing transaction is successfully uploaded, generate synchronization data for a business node based on the target state tree, and synchronize the synchronization data to the business node. The business node belongs to the blockchain.

Specifically, a synchronization leaf node having synchronization permission with the business node is obtained in the target state tree, and a state verification path corresponding to the synchronization leaf node is obtained. The synchronization data is generated based on the synchronization leaf node, the state verification path, and the tree root publishing transaction. The synchronization data is configured for indicating the business node to perform, based on the target tree root in the tree root publishing transaction and the state verification path, validity verification on the synchronization leaf node.

Because a leaf node may be updated before archiving, a state verification path of the leaf node may be changed, but the state verification path is not updated after the leaf node is archived.

S307: If it is detected that a first state subtree satisfying the state archiving condition exists in the target state tree, generate an archiving transaction based on a first leaf node and a first sub-root node that are of the first state subtree.

S308: If the archiving transaction is successfully uploaded, invoke a state archiving function in the smart contract, and archive the first state subtree to the service device by using the state archiving function. A business service provided by the service device is associated with the first business information.

S309: Delete, from the target state tree, a node other than the first sub-root node in the first state subtree. The first sub-root node in the target state tree is configured for indicating that the first state subtree is archived.

For a specific implementation process of S307 to S309, refer to S101 to S103 in the embodiment corresponding to FIG. 3. Details are not described herein.

The embodiments involved in the present disclosure, such as the embodiments respectively corresponding to FIG. 2a, FIG. 2b, FIG. 3, FIG. 6, and FIG. 9, may be combined to generate a new embodiment.

It can be learned from the above that, in this embodiment of the present disclosure, the first state subtree satisfying the state archiving condition may be archived. Through the archiving, storage of old data (including the first state subtree) in the blockchain is reduced, thereby alleviating the storage resource.

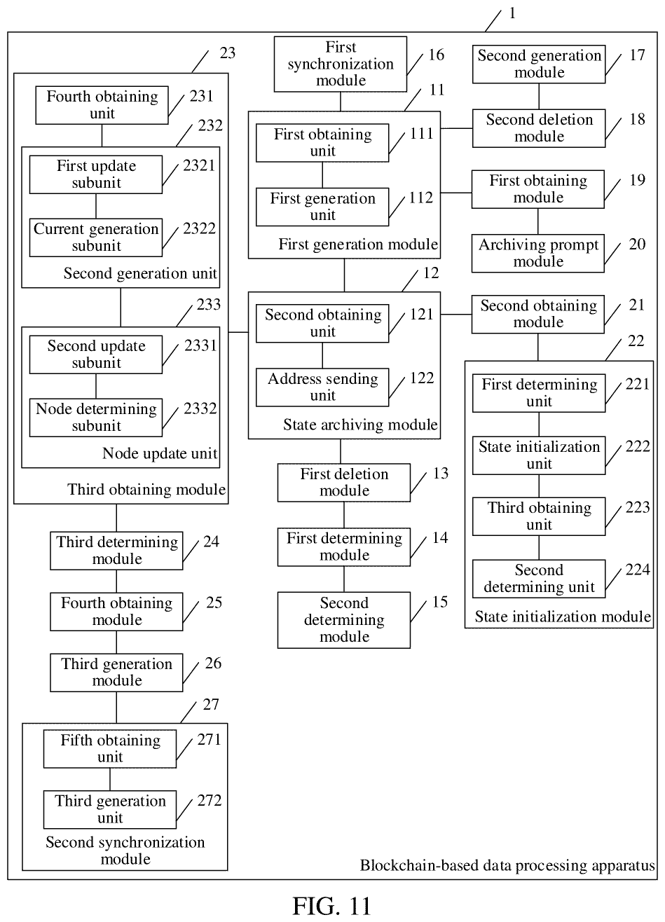

Further, FIG. 11 is a schematic diagram of a structure of a blockchain-based data processing apparatus according to an embodiment of the present disclosure. The blockchain-based data processing apparatus may run in a consensus node, and the consensus node belongs to a blockchain. A blockchain-based data processing apparatus 1 may be configured to perform the corresponding operations in the method provided by the embodiments of the present disclosure. As shown in FIG. 11, the blockchain-based data processing apparatus 1 may include: a first generation module 11, a state archiving module 12, and a first deletion module 13.

The first generation module 11 is configured to: if the consensus node detects that a first state subtree satisfying a state archiving condition exists in a target state tree, generate an archiving transaction based on a first leaf node and a first sub-root node that are of the first state subtree.

The state archiving module 12 is configured to: archive the first state subtree to a service device if the archiving transaction is successfully uploaded.

The first deletion module 13 is configured to: delete, from the target state tree, a node other than the first sub-root node in the first state subtree.

For a specific implementation of functions of the first generation module 11, the state archiving module 12, and the first deletion module 13, refer to S101 to S103 in the embodiment corresponding to FIG. 3, and details are not described herein again.

Refer to FIG. 11 again. The blockchain-based data processing apparatus 1 may further include: a first determining module 14 and a second determining module 15.

The first determining module 14 is configured to: determine a total quantity of first leaf nodes, and if the total quantity of first leaf nodes is greater than or equal to an archiving quantity threshold, obtain a generation timestamp of the first sub-root node.

The second determining module 15 is configured to: determine maintenance duration of the first sub-root node based on the generation timestamp, and if the maintenance duration is greater than or equal to a maintenance duration threshold, determine that the first state subtree satisfies the state archiving condition.

For a specific implementation of functions of the first determining module 14 and the second determining module 15, refer to S101 in the embodiment corresponding to FIG. 3, and details are not described herein again.

Refer to FIG. 11 again. The first generation module 11 may include: a first obtaining unit 111 and a first generation unit 112.

The first obtaining unit 111 is configured to: obtain, in the target state tree, a first index number for the first leaf node.

The first generation unit 112 is configured to: generate the archiving transaction based on the first index number and the first sub-root node of the first state subtree, and upload the archiving transaction.

The blockchain-based data processing apparatus may further include: a first synchronization module 16.

The first synchronization module 16 is configured to: synchronize the archiving transaction to a business node in the blockchain. The archiving transaction is configured for indicating the business node to perform, based on the first sub-root node, validity verification on to-be-verified object information associated with the first index number.

For a specific implementation of functions of the first obtaining unit 111, the first generation unit 112, and the first synchronization module 16, refer to S101 in the embodiment corresponding to FIG. 3, and details are not described herein again.

Refer to FIG. 11 again. The blockchain-based data processing apparatus 1 may further include: a second generation module 17 and a second deletion module 18.

The second generation module 17 is configured to: if a parent node to which a second state subtree belongs and a parent node to which the first state subtree belongs are the same target node in the target state tree, generate a subtree merging transaction based on a second sub-root node of the second state subtree, the first sub-root node, and the target node. The second state subtree is a state subtree satisfying the state archiving condition in the target state tree, and an archiving timestamp corresponding to the second state subtree is earlier than an archiving timestamp corresponding to the first state subtree.

The second deletion module 18 is configured to: upload the subtree merging transaction, and if the subtree merging transaction is successfully uploaded, delete, from the target state tree, both the first sub-root node and the second sub-root node. The target node in the target state tree is configured for indicating that both the first state subtree and the second state subtree are archived.

For a specific implementation of functions of the second generation module 17 and the second deletion module 18, refer to S205 and S206 in the embodiment corresponding to FIG. 6, and details are not described herein again.

Refer to FIG. 11 again. A state archiving function has a function of calling back a first storage address for the first state subtree when the service device successfully stores the first state subtree, and has a function of associatively storing the first storage address and the first sub-root node.

The blockchain-based data processing apparatus 1 may further include: a first obtaining module 19 and an archiving prompt module 20.

The first obtaining module 19 is configured to: obtain a state query request that carries second object information and that is sent by a blockchain node, and determine, based on the state query request, a second index number having a mapping relationship with the second object information in the target state tree.

The archiving prompt module 20 is configured to: if the second index number belongs to the first index number that is for the first leaf node and that is in the target state tree, return archiving prompt information carrying the first storage address and the first sub-root node to the blockchain node. The archiving prompt information is configured for indicating the blockchain node to query, based on the first storage address, the first state subtree in the service device, and obtaining a leaf node corresponding to the second object information in the first state subtree.

For a specific implementation of functions of the first obtaining module 19 and the archiving prompt module 20, refer to the embodiment corresponding to FIG. 2b, and details are not described herein again.

Refer to FIG. 11 again. The state archiving module 12 may include: a second obtaining unit 121 and an address sending unit 122.

The second obtaining unit 121 is configured to: if the parent node to which the second state subtree belongs and the parent node to which the first state subtree belongs are the same target node in the target state tree, obtain a second storage address of the second state subtree in the service device. The second state subtree is the state subtree satisfying the state archiving condition in the target state tree, and the archiving timestamp corresponding to the second state subtree is earlier than the archiving timestamp corresponding to the first state subtree.

The address sending unit 122 is configured to: send the target node, the first state subtree, and the second storage address to the service device respectively, to enable the service device to write the first state subtree and the target node based on the second storage address, and merge the first state subtree and the second state subtree, to obtain a merged state subtree. The target node is a tree root of the merged state subtree.

The first deletion module 13 is further configured to: delete the first sub-root node and the second sub-root node of the second state subtree synchronously. The target node in the target state tree is configured for indicating that both the first state subtree and the second state subtree are archived.

For a specific implementation of functions of the second obtaining unit 121, the address sending unit 122, and the first deletion module 13, refer to S102 in the embodiment corresponding to FIG. 3, and details are not described herein again.

Refer to FIG. 11 again. The state archiving module 12 is specifically configured to: obtain business data associated with the first state subtree in the blockchain, and archive both the business data and the first state subtree to the service device.

The first deletion module 13 is further configured to: if archiving success information that is for the business data and the first state subtree and that is returned by the service device is obtained, delete the business data from the blockchain.

For a specific implementation of functions of the state archiving module 12 and the first deletion module 13, refer to S202 and S203 in the embodiment corresponding to FIG. 6, and details are not described herein again.

Refer to FIG. 11 again. The first object information includes first business information.

The first leaf node is configured for indicating a current state of the first object information, the first object information includes the first business information, and the first business information includes second business information. The blockchain-based data processing apparatus 1 may further include: a second obtaining module 21, a state initialization module 22, a third obtaining module 23, and a third determining module 24.

The second obtaining module 21 is configured to: obtain the first business information provided by the service device.

The state initialization module 22 is configured to: construct an initial state tree including at least two initial leaf nodes in a smart contract. The at least two initial leaf nodes include a first initial leaf node for the first business information, and the first initial leaf node is configured for indicating that a business transaction including the first business information does not exist in the blockchain.

The third obtaining module 23 is configured to: obtain a first business transaction including the second business information, and update, based on first business transaction, the first initial leaf node in the initial state tree to the first leaf node.

The third determining module 24 is configured to: determine, as the target state tree, the initial state tree in which the first leaf node is updated.

For a specific implementation of functions of the second obtaining module 21, the state initialization module 22, the third obtaining module 23, and the third determining module 24, refer to S301 to S303 in the embodiment corresponding to FIG. 9, and details are not described herein again.

Refer to FIG. 11 again. The second obtaining module 21 is specifically configured to: obtain at least two pieces of business information provided by the service device. The at least two pieces of business information include the first business information.

The state initialization module 22 may include: a first determining unit 221, a state initialization unit 222, a third obtaining unit 223, and a second determining unit 224.

The first determining unit 221 is configured to: determine a total quantity of pieces of information of the at least two pieces of business information, and determine, based on the total quantity of pieces of information, a total quantity of leaves.

The state initialization unit 222 is configured to: construct the initial state tree including the at least two initial leaf nodes in the smart contract. A total quantity of at least two initial leaf nodes equal to the total quantity of leaves.

The third obtaining unit 223 is configured to: determine index numbers respectively configured for indicating the at least two initial leaf nodes in the initial state tree. The at least two index numbers include the first index number configured for indicating the first initial leaf node.

The second determining unit 224 is configured to: construct a mapping relationship for the at least two index numbers and the at least two pieces of business information. The mapping relationship exists between the first index number and the first business information.

For a specific implementation of functions of the first determining unit 221, the state initialization unit 222, the third obtaining unit 223, and the second determining unit 224, refer to S301 and S302 in the embodiment corresponding to FIG. 9, and details are not described herein again.

Refer to FIG. 11 again. The third obtaining module 23 may include: a fourth obtaining unit 231, a second generation unit 232, and a node update unit 233.

The fourth obtaining unit 231 is configured to: upload the first business transaction, and if the first business transaction is successfully uploaded, obtain, based on the first business transaction, a current state of the second business information.

The second generation unit 232 is configured to: generate, based on the current state of the second business information, a current state value configured for indicating the current state of the second business information.

The node update unit 233 is configured to: update the first initial leaf node based on the current state value to obtain the first leaf node.

For a specific implementation of functions of the fourth obtaining unit 231, the second generation unit 232, and the node update unit 233, refer to S303 in the embodiment corresponding to FIG. 9, and details are not described herein again.

Refer to FIG. 11 again. The second generation unit 232 may include: a first update subunit 2321 and a current generation subunit 2322.

The first update subunit 2321 is configured to: if a second business transaction including the second business information is obtained within a state update periodicity for the current state of the second business information and the second business transaction is successfully uploaded, obtain, based on the second business transaction, an updated state configured for updating the current state of the second business information.

The current generation subunit 2322 is configured to: if the current state of the second business information is maintained within the state update periodicity, generate the current state value configured for indicating the current state of the second business information.

For a specific implementation of functions of the first update subunit 2321 and the current generation subunit 2322, refer to S303 in the embodiment corresponding to FIG. 9, and details are not described herein again.

Refer to FIG. 11 again. The node update unit 233 may include: a second update subunit 2331 and a node determining subunit 2332.

The second update subunit 2331 is configured to: update an initial state value of the first initial leaf node to the current state value. The first initial leaf node indicates, through the initial state value, that business transaction including the first business information does not exist in the blockchain.

The node determining subunit 2332 is configured to: determine, as the first leaf node, the first initial leaf node in which the current state value is updated.

For a specific implementation of functions of the second update subunit 2331 and the node determining subunit 2332, refer to S303 in the embodiment corresponding to FIG. 9, and details are not described herein again.

Refer to FIG. 11 again. The blockchain-based data processing apparatus 1 may further include: a fourth obtaining module 25, a third generation module 26, and a second synchronization module 27.

The fourth obtaining module 25 is configured to: obtain a target tree root of the target state tree if system time reaches a tree root update periodicity. The target tree root is different from an initial tree root of the initial state tree.

The third generation module 26 is configured to: generate a tree root publishing transaction based on the system time and the target tree root, and upload the tree root publishing transaction.

The second synchronization modules 27 is configured to: if the tree root publishing transaction is successfully uploaded, generate synchronization data for a business node based on the target state tree, and synchronize the synchronization data to the business node. The business node belongs to the blockchain.

For a specific implementation of functions of the fourth obtaining module 25, the third generation module 26, and the second synchronization module 27, refer to S304 to S306 in the embodiment corresponding to FIG. 9, and details are not described herein again.

Refer to FIG. 11 again. The second synchronization module 27 may include: a fifth obtaining unit 271 and a third generation unit 272.

The fifth obtaining unit 271 is configured to: obtain a synchronization leaf node having synchronization permission with the business node in the target state tree, and obtain a state verification path corresponding to the synchronization leaf node.

The third generation unit 272 is configured to: generate the synchronization data based on the synchronization leaf node, the state verification path, and the tree root publishing transaction. The synchronization data is configured for indicating the business node to perform, based on the target tree root in the tree root publishing transaction and the state verification path, validity verification on the synchronization leaf node.

For a specific implementation of functions of the fifth obtaining unit 271 and the third generation unit 272, refer to S306 in the embodiment corresponding to FIG. 9, and details are not described herein again.

In this embodiment of the present disclosure, if it is detected that the first state subtree satisfying the state archiving condition exists in the target state tree, the archiving transaction may be generated based on the first leaf node and the first sub-root node that are of the first state subtree. The first state subtree is archived to the service device if the archiving transaction is successfully uploaded. In addition, the node other than the first sub-root node in the first state subtree is deleted from the target state tree. In this case, the first sub-root node in the target state tree is configured for indicating that the first state subtree is archived. It can be learned from the above that, in this embodiment of the present disclosure, the first state subtree satisfying the state archiving condition may be archived. Through the archiving, storage of old data (including the first state subtree) in the blockchain is reduced, thereby alleviating the storage resource.

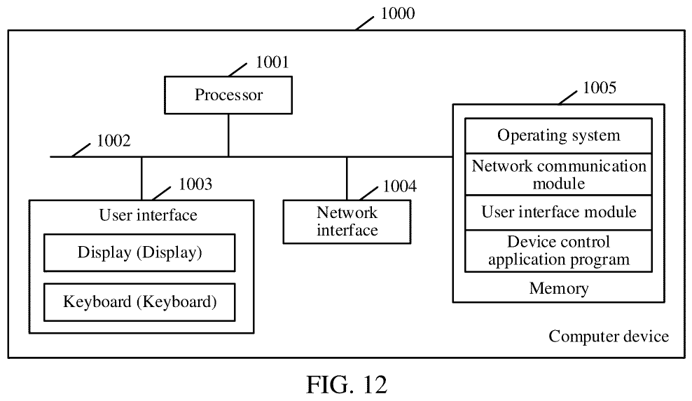

Further, FIG. 12 is a schematic diagram of a structure of a computer device according to an embodiment of the present disclosure. As shown in FIG. 12, a computer device 1000 may include: at least one processor 1001, such as a central processing unit (CPU), at least one network interface 1004, a user interface 1003, a memory 1005, and at least one communication bus 1002. The communication bus 1002 is configured to implement connection and communication between the components. In some embodiments, the user interface 1003 may include a display and a keyboard, and the network interface 1004 may include a standard wired interface or wireless interface (such as a Wi-Fi interface). The memory 1005 may be a high-speed RAM memory, or a non-volatile memory, for example, at least one magnetic disk memory. In some embodiments, the memory 1005 may alternatively be at least one storage apparatus located remotely from the foregoing processor 1001. As shown in FIG. 12, the memory 1005 used as a computer storage medium may include an operating system, a network communication module, a user interface module, and a device control application program.

In the computer device 1000 shown in FIG. 12, the network interface 1004 may provide a network communication function. The user interface 1003 is mainly configured to provide an input interface for a user. The processor 1001 may be configured to invoke the device control application program, stored in the memory 1005, to implement the following operations:
if it is detected that a first state subtree satisfying a state archiving condition exists in a target state tree, generating an archiving transaction based on a first leaf node and a first sub-root node that are of the first state subtree;
archiving the first state subtree to a service device if the archiving transaction is successfully uploaded; and
deleting, from the target state tree, a node other than the first sub-root node in the first state subtree.

The computer device 1000 described in this embodiment of the present disclosure may perform the descriptions of the blockchain-based data processing method or apparatus in the foregoing embodiments, and details are not described herein again. In addition, descriptions of beneficial effects of the same method are not described herein again.

An embodiment of the present disclosure further provides a computer-readable storage medium. The computer-readable storage medium stores a computer program. When being executed by a processor, the computer program implements the descriptions of the blockchain-based data processing method or apparatus in the foregoing embodiments, and details are not described herein again. In addition, descriptions of beneficial effects of the same method are not described herein again.

The foregoing computer-readable storage medium may be the blockchain-based data processing apparatus provided by any one of the foregoing embodiments or an internal storage unit of the foregoing computer device, such as a hard disk or an internal memory of the computer device. The computer-readable storage medium may alternatively be an external storage device of the computer device, such as a plug-in hard disk equipped on the computer device, a smart media card (SMC), a secure digital (SD) card, and a flash card. Further, the computer-readable storage medium may alternatively include both the internal storage unit and the external storage device that are of the computer device. The computer-readable storage medium is configured to store the computer program and other programs and data required by the computer device. The computer-readable storage medium may also be configured to temporarily store data that has been output or will be output.

An embodiment of the present disclosure further provides a computer program product. The computer program product includes a computer program, and the computer program is stored in a computer-readable storage medium. A processor of a computer device reads the computer program from the computer-readable storage medium. The processor executes the computer program to enable the computer device to perform the descriptions of the blockchain-based data processing method or apparatus in the foregoing embodiments, and details are not described herein again. In addition, descriptions of beneficial effects of the same method are not described herein again.

In various embodiments in the present disclosure, a unit may refer to a software unit, a hardware unit, or a combination thereof. A software unit may include a computer program or part of the computer program that has a predefined function and works together with other related parts to achieve a predefined goal, such as those functions described in this disclosure. A hardware unit may be implemented using processing circuitry and/or memory configured to perform the functions described in this disclosure. Each unit can be implemented using one or more processors (or processors and memory). Likewise, a processor (or processors and memory) can be used to implement one or more units. Moreover, each unit can be part of an overall unit that includes the functionalities of the unit. The description here also applies to the term unit and other equivalent terms.

In various embodiments in the present disclosure, a module may refer to a software module, a hardware module, or a combination thereof. A software module may include a computer program or part of the computer program that has a predefined function and works together with other related parts to achieve a predefined goal, such as those functions described in this disclosure. A hardware module may be implemented using processing circuitry and/or memory configured to perform the functions described in this disclosure. Each module can be implemented using one or more processors (or processors and memory). Likewise, a processor (or processors and memory) can be used to implement one or more modules. Moreover, each module can be part of an overall module that includes the functionalities of the module. The description here also applies to the term module and other equivalent terms.

In the specification, claims, and accompanying drawings of embodiments of the present disclosure, the terms “first” “second”, and the like are used to distinguish between different objects but are not used to describe a particular order. In addition, the term “include” and any variant thereof are intended to cover a non-exclusive inclusion. For example, a process, method, apparatus, product, or device that includes a series of operations or units is not limited to the listed operations or modules, but further includes an operation or module that is not listed in some other embodiments, or further includes another operation or unit that is intrinsic to the process, method, apparatus, product, or device in some other embodiments.

A person of ordinary skill in the art may realize that, units and algorithm operations of each example described in combination with the disclosed embodiments herein can be implemented by electronic hardware, computer software, or a combination thereof. To clearly describe the interchangeability between the hardware and the software, compositions and operations of each example have been generally described based on functions in the foregoing descriptions. Whether the functions are executed in the manner of hardware or software depends on particular applications and design constraint conditions of the technical solutions. A person skilled in the art may use different methods to implement the described functions for each particular application, but it is not to be considered that the implementation goes beyond the scope of the present disclosure.

Merely exemplary embodiments of the present disclosure are disclosed above, and certainly are not intended to limit the protection scope of the present disclosure. Therefore, equivalent variations made in accordance with the claims of this application shall fall within the scope of the present disclosure.

What is claimed is:

1. A blockchain-based data processing method, performed by a computer device, and comprising:
in response to determining that a first state subtree satisfying a state archiving condition exists in a target state tree, generating an archiving transaction based on a first leaf node and a first sub-root node that are of the first state subtree;
archiving the first state subtree to a service device in response to the archiving transaction being successfully uploaded; and
deleting, from the target state tree, a node other than the first sub-root node in the first state subtree.

2. The method according to claim 1, further comprises:
determining a total quantity of first leaf nodes;
in response to the total quantity of first leaf nodes being greater than or equal to an archiving quantity threshold, obtaining a generation timestamp of the first sub-root node;
determining maintenance duration of the first sub-root node based on the generation timestamp;
in response to the maintenance duration being greater than or equal to a maintenance duration threshold, determining that the first state subtree satisfies the state archiving condition.

3. The method according to claim 1, wherein:
the generating the archiving transaction based on the first leaf node and the first sub-root node that are of the first state subtree comprises:
obtaining, in the target state tree, a first index number for the first leaf node; and
generating the archiving transaction based on the first index number and the first sub-root node of the first state subtree, and uploading the archiving transaction; and
the method further comprises:
synchronizing the archiving transaction to a business node in the blockchain, wherein the archiving transaction is configured for indicating the business node to perform, based on the first sub-root node, validity verification on to-be-verified object information associated with the first index number.

4. The method according to claim 1, further comprises:
in response to a parent node to which a second state subtree belongs and a parent node to which the first state subtree belongs being the same target node in the target state tree, generating a subtree merging transaction based on a second sub-root node of the second state subtree, the first sub-root node, and the target node, wherein the second state subtree is a state subtree satisfying the state archiving condition in the target state tree, and an archiving timestamp corresponding to the second state subtree is earlier than an archiving timestamp corresponding to the first state subtree;
uploading the subtree merging transaction; and
in response to the subtree merging transaction being successfully uploaded, deleting, from the target state tree, both the first sub-root node and the second sub-root node, wherein the target node in the target state tree is configured for indicating that both the first state subtree and the second state subtree are archived.

5. The method according to claim 1, further comprises:
obtaining a state query request that carries second object information and that is transmitted by a blockchain node;
determining, based on the state query request, a second index number having a mapping relationship with the second object information in the target state tree; and
in response to the second index number belonging to the first index number that is for the first leaf node and that is in the target state tree, returning archiving prompt information carrying a first storage address and the first sub-root node to the blockchain node, wherein the archiving prompt information is configured for indicating the blockchain node to query, based on the first storage address, the first state subtree in the service device, and obtaining a leaf node corresponding to the second object information in the first state subtree.

6. The method according to claim 1, wherein:
the archiving the first state subtree to the service device comprises:
in response to the parent node to which the second state subtree belongs and the parent node to which the first state subtree belongs being the same target node in the target state tree, obtaining a second storage address of the second state subtree in the service device, wherein the second state subtree is a state subtree satisfying the state archiving condition in the target state tree, and the archiving timestamp corresponding to the second state subtree is earlier than the archiving timestamp corresponding to the first state subtree; and
transmitting the target node, the first state subtree, and the second storage address to the service device respectively, to enable the service device to write the first state subtree and the target node based on the second storage address, and merge the first state subtree and the second state subtree to obtain a merged state subtree, wherein the target node is a tree root of the merged state subtree; and
the method further comprises:
synchronously deleting the first sub-root node and the second sub-root node of the second state subtree, wherein the target node in the target state tree is configured for indicating that both the first state subtree and the second state subtree are archived.

7. The method according to claim 1, wherein:
the archiving the first state subtree the a service device comprises:
obtaining business data associated with the first state subtree in the blockchain, and archiving both the business data and the first state subtree to the service device; and
the method further comprises:
in response to archiving success information that is for the business data and the first state subtree and that is returned by the service device being obtained, deleting the business data from the blockchain.

8. The method according to claim 1, wherein:
the first leaf node is configured for indicating a current state of first object information, the first object information comprises first business information, and the first business information comprises second business information; and
the method further comprises:
obtaining the first business information provided by the service device;
constructing an initial state tree comprising at least two initial leaf nodes in a smart contract, wherein the at least two initial leaf nodes comprise a first initial leaf node for the first business information, and the first initial leaf node is configured for indicating that a business transaction comprising the first business information does not exist in the blockchain;
obtaining a first business transaction comprising the second business information;
updating, based on the first business transaction, the first initial leaf node in the initial state tree to the first leaf node; and
determining, as the target state tree, the initial state tree in which the first leaf node is updated.

9. The method according to claim 8, wherein:
the obtaining the first business information provided by the service device comprises:
obtaining at least two pieces of business information provided by the service device, wherein the at least two pieces of business information comprise the first business information; and
the constructing the initial state tree comprising at least two initial leaf nodes in the smart contract comprises:
determining a total quantity of pieces of information of the at least two pieces of business information, and determining, based on the total quantity of pieces of information, a total quantity of leaves;
constructing the initial state tree comprising the at least two initial leaf nodes in the smart contract, wherein a total quantity of at least two initial leaf nodes is equal to the total quantity of leaves;
determining index numbers respectively configured for indicating the at least two initial leaf nodes in the initial state tree, wherein the at least two index numbers comprise the first index number configured for indicating the first initial leaf node; and
constructing a mapping relationship for the at least two index numbers and the at least two pieces of business information, wherein the mapping relationship exists between the first index number and the first business information.

10. The method according to claim 8, wherein the updating, based on the first business transaction, the first initial leaf node in the initial state tree to the first leaf node comprises:
uploading the first business transaction;
in response to the first business transaction being successfully uploaded, obtaining, based on the first business transaction, a current state of the second business information;
generating, based on the current state of the second business information, a current state value configured for indicating the current state of the second business information; and
updating the first initial leaf node based on the current state value to obtain the first leaf node.

11. The method according to claim 10, wherein the generating, based on the current state of the second business information, the current state value configured for indicating the current state of the second business information comprises:
in response to a second business transaction comprising the second business information being obtained within a state update periodicity for the current state of the second business information and the second business transaction is successfully uploaded, obtaining, based on the second business transaction, an updated state configured for updating the current state of the second business information; or
in response to the current state of the second business information being maintained within the state update periodicity, generating the current state value configured for indicating the current state of the second business information.

12. The method according to claim 10, wherein the updating the first initial leaf node based on the current state value to obtain the first leaf node comprises:
updating an initial state value of the first initial leaf node to the current state value, wherein the first initial leaf node indicates, through the initial state value, that the business transaction comprising the first business information does not exist in the blockchain; and
determining, as the first leaf node, the first initial leaf node in which the current state value is updated.

13. The method according to claim 8, further comprises:
obtaining a target tree root of the target state tree in response to a system time reaching a tree root update periodicity, wherein the target tree root is different from an initial tree root of the initial state tree;
generating a tree root publishing transaction based on the system time and the target tree root, and uploading the tree root publishing transaction; and
in response to the tree root publishing transaction being successfully uploaded, generating synchronization data for a business node based on the target state tree, and synchronizing the synchronization data to the business node, wherein the business node belongs to the blockchain.

14. The method according to claim 13, wherein the generating synchronization data for the business node based on the target state tree comprises:
obtaining a synchronization leaf node having synchronization permission with the business node in the target state tree, and obtaining a state verification path corresponding to the synchronization leaf node; and
generating the synchronization data based on the synchronization leaf node, the state verification path, and the tree root publishing transaction, wherein the synchronization data is configured for indicating the business node to perform, based on the target tree root in the tree root publishing transaction and the state verification path, validity verification on the synchronization leaf node.

15. An apparatus for processing a blockchain-based data, the apparatus comprising:
a memory storing instructions; and
a processor in communication with the memory, wherein, when the processor executes the instructions, the processor is configured to cause the apparatus to perform:
in response to determining that a first state subtree satisfying a state archiving condition exists in a target state tree, generating an archiving transaction based on a first leaf node and a first sub-root node that are of the first state subtree;
archiving the first state subtree to a service device in response to the archiving transaction being successfully uploaded; and
deleting, from the target state tree, a node other than the first sub-root node in the first state subtree.

16. The apparatus according to claim 15, wherein, when the processor executes the instructions, the processor is configured to further cause the apparatus to perform:
determining a total quantity of first leaf nodes;
in response to the total quantity of first leaf nodes being greater than or equal to an archiving quantity threshold, obtaining a generation timestamp of the first sub-root node;
determining maintenance duration of the first sub-root node based on the generation timestamp;
in response to the maintenance duration being greater than or equal to a maintenance duration threshold, determining that the first state subtree satisfies the state archiving condition.

17. The apparatus according to claim 15, wherein:
when the processor is configured to cause the apparatus to perform generating the archiving transaction based on the first leaf node and the first sub-root node that are of the first state subtree, the processor is configured to cause the apparatus to perform:
obtaining, in the target state tree, a first index number for the first leaf node; and
generating the archiving transaction based on the first index number and the first sub-root node of the first state subtree, and uploading the archiving transaction; and
when the processor executes the instructions, the processor is configured to further cause the apparatus to perform:
synchronizing the archiving transaction to a business node in a blockchain, wherein the archiving transaction is configured for indicating the business node to perform, based on the first sub-root node, validity verification on to-be-verified object information associated with the first index number.

18. A non-transitory computer-readable storage medium, storing computer-readable instructions, wherein, the computer-readable instructions, when executed by a processor, are configured to cause the processor to perform:
in response to determining that a first state subtree satisfying a state archiving condition exists in a target state tree, generating an archiving transaction based on a first leaf node and a first sub-root node that are of the first state subtree;
archiving the first state subtree to a service device in response to the archiving transaction being successfully uploaded; and
deleting, from the target state tree, a node other than the first sub-root node in the first state subtree.

19. The non-transitory computer-readable storage medium according to claim 18, wherein, when the computer-readable instructions are executed by the processor, the computer-readable instructions are configured to further cause the processor to perform:
determining a total quantity of first leaf nodes;
in response to the total quantity of first leaf nodes being greater than or equal to an archiving quantity threshold, obtaining a generation timestamp of the first sub-root node;
determining maintenance duration of the first sub-root node based on the generation timestamp;
in response to the maintenance duration being greater than or equal to a maintenance duration threshold, determining that the first state subtree satisfies the state archiving condition.

20. The non-transitory computer-readable storage medium according to claim 18, wherein:
when the computer-readable instructions are configured to cause the processor to perform generating the archiving transaction based on the first leaf node and the first sub-root node that are of the first state subtree, the computer-readable instructions are configured to cause the processor to perform:
obtaining, in the target state tree, a first index number for the first leaf node; and
generating the archiving transaction based on the first index number and the first sub-root node of the first state subtree, and uploading the archiving transaction; and
when the computer-readable instructions are executed by the processor, the computer-readable instructions are configured to further cause the processor to perform:
synchronizing the archiving transaction to a business node in a blockchain, wherein the archiving transaction is configured for indicating the business node to perform, based on the first sub-root node, validity verification on to-be-verified object information associated with the first index number.
